(19) United States
(12) Patent Application Publication
(10) Pub. No.: US 2026/0297474 A1
(43) Pub. Date: Oct. 1, 2026

(54) LIQUID COMPOSITION WITH PERFUME CAPSULES

(71) Applicant: THE PROCTER & GAMBLE COMPANY, Cincinnati, OH (US)

(72) Inventors: An PINTENS, Brasschaat (BE); Julien Christian LABIE, Waterloo (BE); Pieter Jan Maria SAVEYN, Destelbergen (BE); Johan SMETS, Lubbeek (BE); Wouter WALRAVENS, Humbeek (BE); Pierre Daniel VERSTRAETE, St-Lambrechts-Woluwe (BE)

(21) Appl. No.: 19/569,311

(22) Filed: Mar. 17, 2026

(30) Foreign Application Priority Data
Mar. 25, 2025 (EP) 25166096.5

(51) Int. Cl. C11D 17/04; C11D 1/29; C11D 1/72; C11D 1/83; C11D 3/22; C11D 3/386; C11D 3/42; C11D 3/43; C11D 3/50

(52) U.S. Cl. CPC C11D 17/045; C11D 1/29; C11D 1/72; C11D 1/8305; C11D 3/227; C11D 3/386; C11D 3/42; C11D 3/43; C11D 3/505; C11D 17/043; C11D 2111/12

(57) ABSTRACT

A liquid composition including i) from 5% to 90% by weight of the composition of a nonionic material selected from the group consisting of non-ionic surfactants, non-aqueous organic solvents, and a mixture thereof; ii) from 1% to 50% by weight of the composition of perfume capsules, wherein the capsules have a core and a shell and wherein the shell surrounds the core wherein the core includes a perfume; iii) from 0.01% to 5% by weight of the composition of a polysaccharide-based cationic polymer; iv) up to 25% by weight of the composition of water; and v) less than 5% by weight of the composition of anionic surfactant.

### TECHNICAL FIELD

The present disclosure is in the field of liquid compositions comprising perfume capsules. It also relates to unit-dose articles comprising perfume capsules, a method of making the liquid composition and a method of laundering using the liquid compositions or the unit-dose articles of the disclosure.

### BACKGROUND

It is common for laundry compositions to have perfumes. Sometimes the perfumes are encapsulated in capsules that protect the perfume and release the perfume at different stages, including after the wash. A problem found with laundry compositions comprising perfume capsules is that the perfume can leak from the capsules, reducing the amount of perfume available during and after the wash. Another negative effect can be that the perfume ingredients, can oxidize other ingredients of the laundry composition, reducing the amount of actives and even the appearance of the product. These problems can be more acute when the laundry composition is enclosed in a water-soluble unit dose article. Unit-dose articles seem to have more design constrains than other laundry detergents because they have the added level of complexity that the composition needs to be low in water and compatible with the water-soluble film. In the case of multi-compartment water-soluble articles, the migrations of ingredients from one compartment to another also needs to be considered.

Perfume capsules can be physically instable when incorporated into laundry compositions. The capsules can separate, aggregate, etc. This makes the product less appealing to the consumer.

The objective of the present disclosure is to provide a composition that provides an improved olfactory experience.

### SUMMARY

According to the first aspect of the disclosure, in an example, there is provided a liquid composition comprising perfume capsules. According to the second aspect of the disclosure, in an example, there is provided a unit-dose article comprising the liquid composition of the disclosure.

According to the third aspect of the disclosure, in an example, there is provided a method for making the composition of the disclosure.

According to the fourth aspect of the disclosure, in an example, there is provided a method of laundering a fabric using the composition or the unit-dose article of the disclosure.

The elements of the composition described in relation to the first aspect of the disclosure, in an example, apply mutatis mutandis to the other aspects of the disclosure.

### DETAILED DESCRIPTION

As used herein, the articles including “the,” “a” and “an” when used in a claim or in the specification, are understood to mean one or more of what is claimed or described.

As used herein, the terms “include,” “includes” and “including” are meant to be non-limiting.

The term “substantially free of” or “substantially free from” as used herein refers to either the complete absence of an ingredient or a minimal amount thereof merely as impurity or unintended byproduct of another ingredient. A composition that is “substantially free” of/from a component means that the composition comprises less than about 0.5%, 0.25%, 0.1%, 0.05%, or 0.01%, or even 0%, by weight of the composition, of the component.

All percentages, ratios and proportions used herein are by weight percent of the composition, unless otherwise specified. All average values are calculated “by weight” of the composition, unless otherwise expressly indicated.

All measurements are performed at 25° C. unless otherwise specified.

Unless otherwise noted, all component or composition levels are in reference to the active portion of that component or composition, and are exclusive of impurities, for example, residual solvents or by-products, which may be present in commercially available sources of such components or compositions.

### Liquid Composition

The present disclosure encompasses a liquid composition. The composition comprises:
i) from 5% to 90% by weight of the composition of a nonionic material selected from the group consisting of non-ionic surfactants, non-aqueous organic solvents, and mixtures thereof;
ii) from 1% to 50% by weight of the composition of perfume capsules, wherein the capsules have a core and a shell and wherein the shell surrounds the core and wherein the core comprises a perfume;
iii) from 0.01% to 5% by weight of the composition of a polysaccharide-based cationic polymer;
iv) up to 25% by weight of the composition of water, preferably from 1% to 25% by weight of the composition of water; and
v) less than 5%, preferably less than 3%, more preferably less than 1% by weight of the composition of anionic surfactant and especially substantially free or free of anionic surfactant.

The nonionic material, perfume capsules and the polysaccharide-based cationic polymer are described in more detail herein below.

The liquid composition comprises from 5% to 90%, preferably from 10% to 90%, preferably from 20% to 90%, more preferably from 30% to 90%, most preferably from 50% to 90% by weight of the composition of a nonionic material selected from the group consisting of non-ionic surfactants, non-aqueous organic solvents, and mixtures thereof. The nonionic material has been found to reduce perfume leakage from perfume capsules. The liquid composition may comprise non-ionic surfactants, preferably alcohol alkoxylated nonionic surfactants and/or EO/PO/EO or PO/EO/PO triblock copolymers. The liquid composition may comprise non-aqueous solvent, preferably selected from the group consisting of glycerol, polyglycerol, alkoxylated polyol or alkoxylated polyol ester solvents, and a mixture thereof, wherein the polyol has from 3 to 5 hydroxyl groups and/or polypropylene glycol having a number average molecular weight of from 700 Da to 5000 Da. Additional non-aqueous solvents can be added to the liquid composition. Preferably the liquid composition comprises less than 5%, preferably less than 3%, more preferably less than 1% of additional non-aqueous solvent, more preferably the liquid composition is substantially free or free of additional non-aqueous solvents selected from the group consisting of propylene glycol, dipropylene glycol, tripropyleneglycol, sorbitol, and a mixture thereof. While such solvents may be preferential in view of optimizing film plasticization properties, they can inhibit the perfume leakage protection benefit provided by the nonionic surfactant or the non-aqueous organic solvent according to the disclosure. Preferably, the composition is substantially free or free of propylene glycol.

The composition may comprise glycerol. The composition may be substantially free or free of polyethylene glycol having a number average molecular weight of from 200 Da to 1000 Da. The composition may comprise glycerol and polyethylene glycol having a number average molecular weight of from 200 Da to 1000 Da, preferably the glycerol and polyethylene glycol having a number average molecular weight of from 200 Da to 1000 Da are in a weight ratio of at least 1.5:1, preferably at least 2:1.

The liquid composition of the disclosure may comprise an ethylene oxide-propylene oxide triblock copolymer having one of the following structures:
a) an ethylene oxide-propylene oxide-ethylene oxide (EO/PO/EO) triblock copolymer, wherein the copolymer comprises a first EO block, a second EO block and PO block and wherein the first EO block and the second EO block are linked to the PO block;
b) a propylene oxide-ethylene oxide-propylene oxide (PO/EO/PO) triblock copolymer, wherein the copolymer comprises a first PO block, a second PO block and EO block and wherein the first PO block and the second PO block are linked to the EO block.

The liquid composition of the disclosure may comprise an alcohol alkoxylated nonionic surfactant and an ethylene oxide-propylene oxide triblock copolymer.

The liquid composition of the disclosure may comprise polypropylene glycol having a number average molecular weight of from 700 Da to 5000 Da, preferably from 700 Da to 4000 Da, preferably from 700 Da to 2500 Da.

The liquid composition of the disclosure may comprise a non-aqueous solvent selected from the group consisting of polyglycerol, alkoxylated polyol or alkoxylated polyol ester solvents, and a mixture thereof; an ethylene oxide-propylene oxide triblock copolymer; glycerol and/or polypropylene glycol having a number average molecular weight of from 700 Da to 5000 Da.

The liquid composition comprises from 1% to 50%, preferably from 1% to 30%, more preferably from 3% to 10% by weight of the liquid composition of perfume capsules. The liquid composition comprises from 0.1% to 10%, preferably from 0.1% to 5%, preferably from 0.5% to 3% by weight of the composition of a polysaccharide-based cationic polymer.

The liquid composition comprises up to 25% by weight of the liquid composition of water, preferably from 1% to less than 25%, preferably from 3% to less than 20%, more preferably from 5% to 15% by weight of the liquid composition of water.

As stated before, the liquid composition comprises less than 5%, preferably less than 3%, more preferably less than 1% by weight of the liquid composition, most preferably is substantially free or free of anionic surfactant. Without wishing to be bound by theory it is believed that presence of anionic surfactant compromises the leakage prevention benefit provided by the nonionic material of the composition of the disclosure.

### Nonionic Surfactant Material

For the purpose of this disclosure, the average degree of ethoxylation refers to the weight average and the average degree of branching refers to the number average.

Suitable nonionic surfactant for use herein includes alcohol alkoxylated nonionic surfactant selected from the group consisting of linear alcohol alkoxylated nonionic surfactant, branched alkoxylated primary alcohol nonionic surfactant, alkoxylated secondary alcohol nonionic surfactant, ethylene oxide-propylene oxide triblock copolymer, and a mixture thereof.

### Alcohol Alkoxylated Nonionic Surfactant

Suitable alcohol alkoxylated nonionic surfactants can have the formula RO-(AO)nH, wherein: R is a primary or secondary C4 to C18, preferably a C6 to C16, more preferably a C6 to C14 branched and/or linear alkyl chain; AO is an ethoxy or propoxy or butoxy unit, or mixtures thereof, and wherein n is on average from 1 to 30, preferably from 3 to 15, more preferably from 5 to 12, even more preferably from 6 to 10. Preferred R chains for use herein are the C₆ to C₁₆ linear or branched alkyl chains, preferably branched alkyl chains. Preferred AO groups are ethoxy groups. n is the average degree of alkoxylation and is preferably between 6 and 10. Most preferably R is a branched C₆ to C₁₆ alkyl chain comprising on average between 6 and 10 ethoxy groups. Alternatively, R is a branched C₆ to C₁₆ alkyl chain comprising on average between 6 and 10 alkoxy groups selected from ethoxy groups, propoxy groups, and a mixture thereof. The AO distribution can be a broad or a narrow (also called peaked) AO distribution. When mixed alkoxy group, they could be randomly ordered or blocked, preferably blocked.

Suitable branched alkoxylated alcohols may be selected from the group consisting of: C₆-C₁₆ alkyl branched alkoxylated alcohols, and mixtures thereof. The branched alkoxylated alcohols can be derived from the alkoxylation of C₆-C₁₆ alkyl branched alcohols selected form the group consisting of C₆-C₁₆ primary mono-alcohols having one or more C₁-C₄ branching groups, or C₆-C₁₆ secondary alcohols.

### Branched Primary Alcohol Alkoxylates

By C₆-C₁₆ primary mono-alcohol, it is meant that the main chain of the primary mono-alcohol has a total of from 6 to 16 carbon atoms. The C₆-C₁₆ primary mono-alcohol can be selected from the group consisting of: ethyl hexanol, propyl hexanol, dimethyl hexanol, trimethyl hexanol, methyl heptanol, ethyl heptanol, propyl heptanol, dimethyl heptanol, trimethyl heptanol, methyl octanol, ethyl octanol, propyl octanol, butyl octanol, dimethyl octanol, trimethyl octanol, methyl nonanol, ethyl nonanol, propyl nonanol, butyl nonanol, dimethyl nonanol, trimethyl nonanol, methyl decanol, ethyl decanol, propyl decanol, butyl decanol, dimethyl decanol, trimethyl decanol, methyl undecanol, ethyl undecanol, propyl undecanol, butyl undecanol, dimethyl undecanol, trimethyl undecanol, methyl dodecanol, ethyl dodecanol, propyl dodecanol, butyl dodecanol, dimethyl dodecanol, trimethyl dodecanol, and mixtures thereof.

The C₆-C₁₆ primary mono-alcohols can be selected from the group consisting of ethyl hexanol, propyl hexanol, ethyl heptanol, propyl heptanol, ethyl octanol, propyl octanol, butyl octanol, ethyl nonanol, propyl nonanol, butyl nonanol, and mixtures thereof. Preferably the C₄-C₁₀ primary mono-alcohol is selected from the group consisting of ethyl hexanol, propyl hexanol, ethyl heptanol, propyl heptanol, and mixtures thereof.

In the primary branched alkoxylated alcohol, the C₁-C₄ branching group can be preferably substituted into the C₆-C₁₆ primary mono-alcohol at the C₂ position, as measured from the hydroxyl group of the starting alcohol. Optionally there can be further branching groups present further down the alkyl chain.

Especially preferred branched primary mono-alcohols are guerbet mono-alcohols. The C₆-C₁₆ primary mono-alcohol is most preferably ethyl hexanol, and propyl heptanol.

The branched alkoxylated alcohol can comprise on average from 1 to 30, preferably from 2 to 15, more preferably from 3 to 12 even more preferably from 4 to 9 ethoxylate units, and optionally from 1 to 9, preferably from 2 to 7, more preferably from 3 to 6 of propoxylate units.

The branched alkoxylated alcohol is preferably 2-ethyl hexan-1-ol, such as guerbet 2-ethyl hexan-1-ol, ethoxylated to an average degree of from 4 to 6, and propoxylated to an average degree of from 4 to 6, more preferably, the alcohol is first propoxylated and then ethoxylated. Another preferred branched alkoxylated alcohols are 2-alkyl-1-alkanols such as alkoxylated C₁₀ guerbet alcohols with on average 1 to 14, preferably from 4 to 12, more preferably from 6 to 10 ethoxylate or ethoxylate-propoxylate units, preferably wherein the alcohol is first propoxylated and then ethoxylated.

Non-limiting examples of suitable branched alkoxylated alcohols are, for instance, Ecosurf® EH3, EH6, and EH9 ethoxylated guerbet alcohols, commercially available from DOW, and Lutensol® XP alkoxylated Guerbet alcohols & Lutensol® XL ethoxylated Guerbet alcohols available from BASF.

### Linear/Linear-Branched Primary Alcohol Alkoxylates

The alkoxylated alcohol nonionic surfactant may also be a primary linear alkoxylated alcohol nonionic surfactant or a mixture of linear and branched alkoxylated alcohol nonionic surfactant. Linear or mixed linear/branched alcohol alkoxylated nonionic surfactants preferred herein are alkoxylated nonionic surfactants with a C₈ to C₁₈, preferably a C₈ to C₁₆, more preferably a C₁₀ to C₁₅, most preferably of C₁₂ to C₁₅ linear or mixed linear/branched alkyl chain comprising on average from 1 to 30, preferably from 3 to 15, more preferably from 5 to 12, even more preferably from 6 to 10 ethoxylate units.

Non-limiting examples of suitable linear or mixed linear/branched primary alkoxylated nonionic surfactants for use herein are Dobanol® 91-2.5 (R is a mixture of C₉ and C₁₁ alkyl chains, n is on average 2.5), Dobanol® 91-5 (R is a mixture of C₉ to C₁₁ alkyl chains, n is on average 5); Dobanol® 91-10 (R is a mixture of C₉ to C₁₁ alkyl chains, n is on average 10); Greenbentine DE60 (R is a C₁₀ linear alkyl chain, n is on average 6); Marlipal 10-8 (R is a C₁₀ linear alkyl chain, n is on average 8); Neodol 91-8 (R is a mixture of C₉ to C₁₁ alkyl chains, n is on average 8); Empilan® KBE21 (R is a mixture of C₁₂ and C₁₄ alkyl chains, n is on average 21); Lutensol ON30 (R is C₁₀ linear alkyl chain, n is on average 3); Lutensol ON50 (R is C₁₀ linear alkyl chain, n is on average 5); Lutensol ON70 (R is C₁₀ linear alkyl chain, n is on average 7); Novel 610-3.5 (R is mixture of C₆ to C₁₀ linear alkyl chains, n is on average 3.5); Novel 810FD-5 (R is mixture of C₈ to C₁₀ linear alkyl chains, n is on average 5); Novel 10-4 (R is C₁₀ linear alkyl chain, n is on average 4); Novel 1412-3 (R is mixture of C₁₂ to C₁₄ linear alkyl chains, n is on average 3); Lialeth® 11-5 (R is a C₁₁ linear alkyl chain, n is on average 5); Lialeth® 11-21 (R is a mixture of linear and branched C₁₁ alkyl chain, n is on average 21), Tomadol 25-7 (R is a mixture of C₁₂ to C₁₅ alkyl chains, n is on average 7), or mixtures thereof.

### Secondary Branched Alcohol Alkoxylates

Alternatively the branched alkoxylated alcohol can be a secondary branched alkoxylated alcohol, having the branching on the C1 position, as measured from the hydroxyl group of the starting alcohol. The alkoxylated nonionic surfactant may be a secondary alcohol ethoxylate such as for example the Tergitol™-15-S surfactants having the general formula shown below and commercially available from DOW.

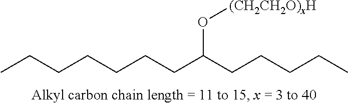

Tergitol 15-S surfactants Preferred secondary alcohol ethoxylate surfactants have on average 3-9 EO units.

Another suitable alkoxylated nonionic surfactant is an alkyl ethoxy alkoxy alcohol, preferably wherein the alkoxy part of the molecule is propoxy, or butoxy, or propoxy-butoxy. More preferred alkyl ethoxy alkoxy alcohols are of formula (II):

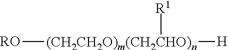

wherein:
R is a branched or unbranched alkyl group having 8 to 16 carbon atoms;
R¹ is a branched or unbranched alkyl group having 1 to 5 carbon atoms;
n is on average from 1 to 10; and m is on average from 6 to 35.
R is preferably from 12 to 15, preferably 13 carbon atoms. R¹ is preferably a branched alkyl group having from 1 to 2 carbon atoms. n is preferably 1 to 5. m is preferably from 8 to 25. Preferably, the weight average molecular weight of the ethoxylated alkoxylated nonionic surfactant of formula (II) is from 500 to 2000 g/mol, more preferably from 600 to 1700 g/mol, most preferably 800 to 1500 g/mol. Preferably the ethoxy and alkoxy groups are arranged in blocks, more preferably the ethoxy group is bound first to the starting alcohol material, followed by the alkoxy group being further bound to the ethoxy group, as shown in Formula II above.

Suitable examples of primary and secondary linear and branched ethoxylated alkoxylated nonionic surfactants are described in Chapter 7 of Surfactant Science and Technology, Third Edition, Wiley Press, ISBN 978-O-471-68024-6.

Most preferably the alkoxylated alcohol nonionic surfactant is selected from the group consisting of: 2-propylheptyl EO8 (Lutensol XL89-BASF); 2-propylheptyl EO5 (Lutensol XL50-BASF); C₁₀ alcohol EO5 (Lutensol ON 50-BASF); C₁₀-alcohol EO7 (Lutensol ON 70-BASF); C₈-C₁₀ EO5 (Novel 810 FD5 Sasol); C₁₀ EO4 (Novel 10-4 Sasol); Tergitol 15-S-3; Tergitol 15-S-5; Tergitol 15-S-7; and Ethyl hexanol PO5EO6 (Ecosurf EH6-Dow). The number behind the alkoxy e.g. ethoxy (EO) group represents the average number of alkoxy groups present.

The presence of alcohol alkoxylated nonionic surfactant further boost the cleaning performance of the liquid composition while contributing to the leakage prevention without negatively impacting the interaction of the liquid composition with a water-soluble film.

### Ethylene Oxide-Propylene Oxide Triblock Copolymer

The ethylene oxide-propylene oxide triblock copolymer has one of the following structures:
a) an ethylene oxide-propylene oxide-ethylene oxide (EO/PO/EO) triblock copolymer, wherein the copolymer comprises a first EO block, a second EO block and PO block and wherein the first EO block and the second EO block are linked to the PO block (I);
b) a propylene oxide-ethylene oxide-propylene oxide (PO/EO/PO) triblock copolymer, wherein the copolymer comprises a first PO block, a second PO block and EO block and wherein the first PO block and the second PO block are linked to the EO block (II)

In other words, for the ethylene oxide-propylene oxide-ethylene oxide (EO/PO/EO) triblock copolymer the PO block is positioned between the two EO blocks. The copolymer may consist of a first EO block, a second EO block and PO block wherein the first EO block and the second EO block are linked to the PO block. By ‘linked to the PO block’, we herein mean the EO-PO-EO blocks have the following structure (I);

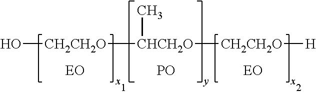

wherein X1 is preferably on average between 1 and 60, preferably between 1 and 50 more preferably between 2 and 40, even more preferably between 3 and 30, most preferably between 5 and 25;
X2 is preferably on average between 1 and 60, preferably between 1 and 50 more preferably between 2 and 40, even more preferably between 3 and 30, most preferably between 5 and 25;
Y is preferably on average between 5 and 80, preferably between 6 and 70, more preferably between 7 and 60, even more preferably between 8 and 55, most preferably between 10 and 50.

Most preferably the ethylene oxide-propylene oxide triblock copolymer according to formula I has on average an X1 value of from 5 to 25, a y value of from 10 to 50 and an X2 value of from 5 to 25.

In the case of the propylene oxide-ethylene oxide-propylene oxide (PO/EO/PO) triblock copolymer the EO block is positioned between the two PO blocks. The copolymer may consist of a first PO block, a second PO block and EO block wherein the first PO block and the second PO block are linked to the EO block.

By ‘linked to the PO block’, we herein mean that the PO-EO-PO blocks have the following structure HO—(PO)y2(EO)x3(PO)y3-H (II);
wherein y2 is preferably on average between 2 and 60, preferably between 3 and 50 more preferably between 4 and 40, even more preferably between 5 and 30, most preferably between 10 and 25;
y3 is preferably on average between 2 and 60, preferably between 3 and 50 more preferably between 4 and 40, even more preferably between 5 and 30, most preferably between 10 and 25;
x3 is preferably on average between 3 and 70, preferably between 5 and 60, more preferably between 7 and 50, even more preferably between 8 and 40, most preferably between 10 and 30. Most preferably the ethylene oxide-propylene oxide triblock copolymer according to formula II has on average a y2 value of from 10 to 25, an x3 value of from 10 to 30 and a y3 value of from 10 to 25.

The ethylene oxide-propylene oxide triblock copolymer of Formula I and Formula II have a cloud point lower than 50° C., preferably lower than 40° C.

Preferably, the ethylene oxide-propylene oxide triblock copolymers of Formula I and

Formula II have a weight average molecular weight of between 1000 and 10,000 Daltons, preferably between 1200 and 8000 Daltons, more preferably between 1500 and 7000 Daltons, even more preferably between 1750 and 5000 Daltons, most preferably between 2000 and 4000 Daltons.

Preferred triblock copolymers of formula I include EO1-PO15-EO1, EO6-PO21-EO6, EO13-PO30-EO13, EO8-PO47-EO8 and EO21-PO47-EO21. Preferred triblock copolymers of formula II include PO21-EO14-PO21 and PO14-EO24-PO14.

Preferably, the ethylene oxide-propylene oxide triblock copolymer of formula I comprises on average between 10% and 90%, preferably between 20% and 70%, most preferably between 30% and 50% by weight of the copolymer of the combined ethylene-oxide blocks. Most preferably the total ethylene oxide content is split over the two ethylene oxide blocks such that each ethylene oxide block comprises on average between 40% and 60% preferably between 45% and 55%, even more preferably between 48% and 52%, most preferably 50% of the total number of ethylene oxide units, wherein the percentage of both ethylene oxide blocks accounts for 100% of the ethylene oxide units present.

Preferably, the ethylene oxide-propylene oxide triblock copolymer of formula II comprises on average between 10% and 90%, preferably between 30% and 85%, most preferably between 50% and 80% by weight of the copolymer of the combined propylene-oxide blocks. Most preferably the total propylene oxide content is split over the two propylene oxide blocks such that each propylene oxide block comprises on average between 40% and 60% preferably between 45% and 55%, even more preferably between 48% and 52%, most preferably 50% of the total number of propylene oxide units, wherein the percentage of both propylene oxide blocks accounts for 100% of the propylene oxide units present.

Suitable ethylene oxide-propylene oxide triblock copolymers are commercially available under the Pluronic PE and Pluronic RPE series from the BASF company, or under the Tergitol L series from the Dow Chemical Company. Particularly suitable materials are Pluronic PE 3100, Pluronic PE 4300, Pluronic PE 6400, Pluronic PE 9200, Pluronic PE 9400, Tergitol L81, Tergitol L62, Tergitol L61, Pluronic RPE 1740, Pluronic RPE 3110 and Pluronic RPE 2520.

### Non-Aqueous Solvent

The liquid composition might comprise from 5% to 90%, preferably from 30% to 90%, more preferably from 40% to 90% by weight of the liquid composition of a non-aqueous solvent comprising a solvent selected from the group consisting of:
i) glycerol, polyethylene glycol, and a mixture thereof;
ii) polyglycerol, alkoxylated polyol, alkoxylated polyol ester, and a mixture thereof, wherein the polyol has from 3 to 5 hydroxyl groups; and/or
iii) polypropylene glycol having a number average molecular weight of from 700 Da to 5000 Da

### Alkoxylated Polyol and Alkoxylated Polyol Esters

The alkoxylated polyol has a polyol core with three to five —OH groups, wherein at least one of the —OH groups is modified to form a polyalkylene oxide branch.

The alkoxylated polyols are based on polyols that have three to five —OH groups in total. The polyol core used to prepare the alkoxylated polyols may be a monomer or may be oligo- or polymer build up by an assembly process comprising —OH groups containing subunits. Also, in case the polyol core is based on an oligomer or polymer the total number of —OH groups is three to five, too. This means that the average number of —OH groups in the inventive compound is not restricted to only three, four and five but can also be every decimal number between three and five.

For example, diglycerol possesses four —OH groups and triglycerol possesses five —OH groups. The skilled person understands that a polyglycerol (n=2 to 3) mixture of diglycerol and triglycerol can be prepared, wherein the (population of) polyol has a total number of —OH groups that lies between three and five. Depending on the ratio of diglycerol and the ratio of triglycerol any decimal number between four and five can be adjusted.

Thus, the alkoxylated polyols of the disclosure may be a homomeric or heteromeric group of molecules based on polyols that have three to five —OH groups. Preferably, the alkoxylated polyols is based on a polyol having three —OH groups.

The term “—OH group”, as used herein, refers to hydroxyl groups, in particular alcohol groups. The term includes all alcohol groups independent of the status of its carbon atom. Thus, in the sense of the present disclosure primary, secondary as well as tertiary alcohols fall within the meaning of “—OH group”. Preferably, the alkoxylated polyol has a linear backbone of carbon atoms. Not included within the scope of the term “—OH group” are —OH groups that are part of carboxylic acids.

The polyol reacted with alkylene oxide does not comprise further functional groups (such as amines, esters, carbonyl, carbonic acids, phosphate, sulfonate groups etc. and derivatives thereof) besides the —OH groups.

At least one of the —OH groups (of the polyol core) is modified to form an alkylene oxide branch, wherein the alkoxylated polyol comprises polyethylene oxide branches comprising on average at least three polyethylene oxide units, preferably, polyethylene oxide branches comprising on average 3 to 10 ethylene oxide units. More detailed embodiments describing the different chain lengths are provided below.

It is noted that all such numbers are numbers “on average” meaning that such numbers refer to the average number for such unit per —OH group calculated based on all —OH groups of an alkoxylated polyol.

The reactions leading to the alkoxylated polyols, are statistical reactions, meaning there is never just one chemically exactly defined compound present, but an alkoxylated polyol always is a mixture of slightly deviating structures, all stemming from the same reaction within one reaction space.

Therefore, unless otherwise indicated, the values, ranges and ratios given in the specification for the number of —OH groups and the molecular weight (Mn) relate to the number average values in heterogenic mixture of the synthesized alkoxylated polyols containing individual, slightly from each other deviating chemical structures that result from the preparation method of the present disclosure. As known in polymer science, the weight-average molecular weight (Mw) is then a measure for the (in)homogeneity within the mixture of different species in “the alkoxylated polyols”.

The polyol may comprise impurities or other types of polyols in an amount up to not more than 10% w/w, not more than 7% w/w, not more than 5% w/w, not more than 3% w/w, not more than 2% w/w, not more than 1% w/w, not more than 0.5% w/w or not more than 0.1% w/w.

The polyol core preferably is a monomer, oligomer or polymer, wherein each of the oligomer and the polymer comprise a plurality of subunits, preferably the oligomer is a homooligomer or the polymer is a heteropolymer. Preferably, the polyol core is a monomer.

Preferably, the polyol core is selected from the group consisting of glycerol, meso-Erythritol, D-threitol, L-threitol, 1,2,5,6-hexanetetrol, pentaerythritol, xylitol, ribitol, arabitol, pentitol, diglycerol, triglycerol, and polyglycerol and wherein the polyglycerol preferably consists of two to three subunits of glycerol. More preferably, the polyol core is glycerol.

The alkoxylated polyol comprises alkylene oxide branches comprising on average at least at least 3 polyethylene oxide units (EOs), preferably at least 5 EOs, more preferably at least 10 EOs. In even more preferred embodiments, the alkylene oxide branches comprise on average 3 to 30 EOs, more preferably from 5 to 25 and especially from 10 to 20 EO.

In preferred embodiments, one alkylene oxide branch has an average weight ranging from 80 to 450 g/mol, preferable from 100 to 300 g/mol.

The alkoxylated polyol can comprise alkylene oxide branches comprising on average not more than 10 polypropylene oxide (POs) units, preferably not more than 5 POs and more preferably not more than 2 POs. In even more preferred embodiments, the alkylene oxide branches essentially consist of ethylene oxide units.

The term “average number of EOs per alkylene oxide branch”, as used herein, refers to the calculated number of EO units that should be present in one alkylene oxide branch. As explained in more detail above, the skilled person is well-aware of the fact that the synthesis of the inventive compounds will result in a mixture of slightly deviating compounds underlying a statistical distribution. Thus, the “average number of EOs per alkylene oxide branch” is calculated by dividing the total amount of employed mol EO per mol of polyol by the (average) number of —OH groups of the polyol (or the mixture of polyols).

The term “average number of ether linkages in the polyol core”, as used herein, refers to the calculated number of ether bonds that are present in one polyol molecule. As the polyol may be a mixture of deviating compounds, the “average number” may refer to the arithmetic average derived from the polyols of the mixture. For example, diglycerol has 1 ether linkage, triglycerol has 2 ether linkages. Polyglycerol with 50% diglycerol and 50% triglycerol has on average 1.5 ether linkages.

The term “average number of —OH groups in the polyol core”, as used herein, refers to the calculated number of —OH groups that should be present in one polyol molecule. As the polyol may be a mixture of deviating compounds, the “average number” may refer to the arithmetic average derived from the polyols of the mixture.

Preferably, the weight average molecular weight (Mw) of the alkoxylated polyol is in the range of from 400 to 1500 g/mol, preferable from 450 to 1300 g/mol, and more preferably from 500 to 1000 g/mol.

Preferably, the alkoxylated polyol is ethoxylated glycerol with on average 10 to 20 EO units per polyalkylene oxide branch. Commercial examples include Glicerodac 7,5 (Sasol), Glicerodac 15 (Sasol), Glicerodac 20 (Sasol), Glicerodac 40 (Sasol), UCON™ Lubricant TPEG 500 (Dow), UCON™ Lubricant TPEG 900 (Dow).

The person skilled in the art knows how to determine/measure the respective weight average molecular weight (MW). This can be done, for example, by size exclusion chromatography (such as GPC, e.g., in combination with light scattering). Preferably, MW values are determined by the method as follows: OECD TG 118 (1996), which means in detail OECD (1996), Test No. 118: Determination of the Number-Average Molecular Weight and the Molecular Weight Distribution of Polymers using Gel Permeation Chromatography, OECD Guidelines for the Testing of Chemicals, Section 1, OECD Publishing, Paris, also available on the internet, for example, under https://doi.org/10.1787/9789264069848-en.

Molecular weights of the polyol starting materials may be determined as described above. Molecular weights of the alkoxylated polyol may be determined by gel permeation chromatography (GPC). The samples were prepared as follows: approx. 15 mg sample was dissolved in 10 ml eluent (THF+0.035 mol/L Diethanolamine) for 1 hour at a temperature of 50° C. All sample solutions were filtered by a Chromafil Xtra PTFE (0.20 μm filtered prior to injection). Sealed sample vials were placed into the auto sampler. An Agilent 1200 HPLC system, consisting of an isocratic pump, vacuum degasser, auto sampler and a column oven was used. Furthermore, the Agilent system contains a Differential Refractive Index (DRI) and a variable Ultra Violet (UVW) Detector for detection. Data acquisition and data processing of conventionally SEC data was done by WinGPC Unichrom, build 6999, of PSS (Polymer Standard Services now part of Agilent). A combination of a SDV guard (7,5×50 mm) column and 3 SDV columns (1000 A, 100000 A and 1000000 A, all 7,5×300 mm) of PSS were put in series at 60° C. THF+0.035 mol/L Diethanolamine was used as eluent at a flow rate of 1 mL/min. 100 μL of each sample solution was injected. The calibration was obtained by narrow molar mass distributed Polyethyleneoxide standards (Agilent) having a molar mass range of M=160 till M=1.378.000 g/mol. Molar masses outside this range were extrapolated.

“Mw” is the weight average molecular weight and “Mn” is number average molecular weight. The respective values of Mw and/or Mn can be determined as described within the experimental section below.

The molar mass distribution Mw/Mn obtained by GPC is equal to the polydispersity index (PDI), the PDI being without unit [g/mol/g/mol]).

The skilled person will understand that the polyols may also be alkoxylated with other AOs than polyethylene oxide. In this context, propylene oxide and butylene oxide are mentioned. Further, the skilled person is also well-aware of helpful modifications of the alkoxy chain, such as modifications with lactones or hydroxy carbon acid as described in WO2021165468 A.

It is noted that the alkylene oxide used to prepare the alkoxylated polyols may be derived from a fossil or non-fossil carbon source or even a mixture of the before mentioned. Preferably, the amount of non-fossil carbon atoms in the alkoxy side chains is at least 10%, at least 20%, at least 40%, at least 70%, at least 95% or it solely comprises non-fossil derived carbon atoms. The skilled person is well-aware of commercial alkylene oxide products made of non-fossil carbon sources (these products are often sold as being sustainable, renewable or bio-based). For example, Croda International, Snaith, UK, sells ethylene oxide and related products based on bio-ethanol as ECO Range. Additionally, methods to prepare bio-based propylene oxide are also known (see Abraham, D. S., “Production of propylene oxide from propylene glycol” Master's Thesis University of Missouri-Columbia (2007) (75 pages)).

It is noted that in preferred embodiments, the polyol core at least comprises two “terminal” primary alcohol groups.

The non-aqueous solvent may also comprise an alkoxylated polyol ester, preferably an alkoxylated glycerol ester, more preferably an ethoxylated glycerol ester. Such alkoxylated polyol ester maybe formulated on top of or in combination with the alkoxylated polyols or polyglycerols described herein. These include esters obtained through the reaction of above described alkoxylated polyols with carboxylic acids/fatty acids.

### Polyglycerols

The non-aqueous solvent may comprise a polyglycerol. The polyglycerol comprises from 2 to 12 glycerol units, preferably from 2 to 5 glycerol units, more preferably the polyglycerol comprises a diglycerol, a triglycerol or a mixture thereof, most preferably diglycerol. Such polyglycerols can be formulated instead of or in combination with the alkoxylated polyols, including alkoxylated polyglycerols, or alkoxylated polyol esters described herein.

Polyglycerols have been known since the beginning of the 20th century. Polyglycerol is a polyol consisting of two or more molecules of glycerol bounded by an ether linkage. Typically, polyglycerols contain several oligomers with a wide distribution. For example, Polyglycerol-2 can contain 30 to 40 wt. % diglycerol and up to 40 wt. % glycerol, the remainder consisting of higher oligomers. However, also high purity polyglycerols can be obtained by reacting glycerol (synthetic or natural origin) and epichlorohydrin, followed by hydrolysis, neutralization and purification. Following this process the acyclic isomers are well defined with a high level of a, a′-diglycerol. Examples of polyglycerol compounds according to the disclosure are selected from the group consisting of Diglycerol, Polyglycerol-3, Polyglycerol-4, Polyglycerol-5, Polyglycerol-6, Polyglycerol-7, Polyglycerol-8, Polyglycerol-9, Polyglycerol-10, Polyglycerol-11, Polyglycerol-12, and mixtures thereof.

The polyglycerols may be hyperbranched or dendritic polyglycerols such as Polyglycerin 10, i.e. polyglycerol with a large number of branches (preferably at least 7 polyether branches) in the molecule. Their synthesis is inter alia described by Haag et al. in JACS 2000, 122, 2954-2955 and Stumbé et al., Poly. Mat. Sci. Eng. 2001, 84, 1023-1024. Their molecular weight is preferably in the range of 1000 to 30000 g/mol. The molecular weight distribution is preferably narrow, that is the apparent polydispersity Mw/Mn is usually below 1.5 (determined by size exclusion chromatography vs. polypropylene oxide standards). Suitable hyperbranched polyglycerols are available from Hyperpolymers GmbH, D79104 Germany.

As stated in the alkoxylated polyol section, optionally, the polyglycerol of the composition of the disclosure is alkoxylated. Preferred alkoxylated polyglycerols are compounds obtained by reaction with ethylene oxide in a matter known to the skilled in the art. Preferred polyglycerols have an average ethoxylation degree from 2 to 12, preferably from 0.5 to 10, more preferably from 1 to 5 per hydroxyl group.

According to the disclosure, the liquid composition may contain mixtures of alkoxylated (preferably ethoxylated) and non-alkoxylated (non-ethoxylated) polyglycerol, the weight ratio of non-ethoxylated polyglycerol to ethoxylated polyglycerol being in the range of 10:1 to 1:10, preferably from 5:1 to 1:5, more preferably from 3:1 to 1:1.

According to the disclosure, the liquid composition may contain mixtures of alkoxylated (preferably ethoxylated) polyols and non-alkoxylated (non-ethoxylated) polyglycerol, the weight ratio of non-ethoxylated polyglycerol to ethoxylated polyol being in the range of 10:1 to 1:10, preferably from 5:1 to 1:5, more preferably from 3:1 to 1:3.

### Polypropyleneglycol

Polypropyleneglycol is also often referred to as polypropylene oxide, the polymerization product of propylene glycol. The polypropyleneglycol has a number average molecular weight of from 700 Da to 5000 Da, preferably from 700 Da to 3000 Da, more preferably from 700 Da to 2500 Da. The molecular weight can be determined by any suitable means, such as described in Polymer Letters, v. 4, pp. 837-841 (1966), or J. Polym. Sci: Part A, v. 1, pp. 1041-1048 (1963). The polypropyleneglycol comprises, preferably consists of poly-1,2-propyleneglycol.

Polypropylene glycol can be produced through the ring-opening polymerization of propylene oxide. Suitable initiators include an alcohol with a base, such as potassium hydroxide, as a catalyst. When the initiator is ethylene glycol or water the polymer is linear. With a multi-functional initiator such as glycerine, pentaerythritol or sorbitol, the resultant polymer is branched. Linear polypropyleneglycol, especially linear poly-1,2-propyleneglycol is most preferred. Poly-1,2-propyleneglycol of the desired molecular weight is commercially available from the Dow company under the Polyglycol P tradename. Alternatively poly-1,2-propyleneglycol of the desired molecular weight can be ordered from Sigma Aldrich.

Preferably, when the composition comprises glycerol, the composition is free of polyethylene glycol having a number average molecular weight of from 200 Da to 1000 Da; or

The composition comprises glycerol and polyethylene glycol, having a number average molecular weight of from 200 Da to 1000 Da, in a weight ratio of at least 1.5, preferably at least 2.

### Perfume Capsules

The liquid composition of the disclosure comprises from 1% to 50%, preferably from 1% to 30%, more preferably from 3% to 10% by weight of perfume capsules. The perfume capsules have a core surrounded by a shell. As used herein, “shell” and “wall” are used interchangeably with regard to the perfume capsules, unless indicated otherwise. The core comprise perfume and optionally a partitioning modifier (e.g., isopropyl myristate). The shell may include melamine, polyacrylamide, silicones, silica, polystyrene, polyurea, polyurethanes, polyacrylate based materials, polyacrylate esters based materials, gelatine, styrene malic anhydride, polyamides, aromatic alcohols, polyvinyl alcohol, or mixtures thereof. The melamine wall material may comprise melamine crosslinked with formaldehyde, melamine-dimethoxyethanol crosslinked with formaldehyde, and mixtures thereof; capsules with such wall materials may be used in combination with a formaldehyde scavenger, such as acetoacetamide, urea, or derivatives thereof.

Preferably, the capsules have a core: wall weight ratio of from about least 80:20, more preferably 90:10 and even more preferably 95:5.

The polyacrylate based wall materials may comprise polyacrylate formed from methylmethacrylate/dimethylaminomethyl methacrylate, polyacrylate formed from amine acrylate and/or methacrylate and strong acid, polyacrylate formed from carboxylic acid acrylate and/or methacrylate monomer and strong base, polyacrylate formed from an amine acrylate and/or methacrylate monomer and a carboxylic acid acrylate and/or carboxylic acid methacrylate monomer, and mixtures thereof.

The polyacrylate ester-based wall materials may comprise polyacrylate esters formed by alkyl and/or glycidyl esters of acrylic acid and/or methacrylic acid, acrylic acid esters and/or methacrylic acid esters which carry hydroxyl and/or carboxy groups, and allylgluconamide, and mixtures thereof.

The aromatic alcohol-based wall material may comprise aryloxyalkanols, arylalkanols and oligoalkanolarylethers. It may also comprise aromatic compounds with at least one free hydroxyl-group, especially preferred at least two free hydroxy groups that are directly aromatically coupled, wherein it is especially preferred if at least two free hydroxy-groups are coupled directly to an aromatic ring, and more especially preferred, positioned relative to each other in meta position. It is preferred that the aromatic alcohols are selected from phenols, cresoles (o-, m-, and p-cresol), naphthols (alpha and beta-naphthol) and thymol, as well as ethylphenols, propylphenols, fluorophenols and methoxyphenols.

The polyurea based wall material may comprise a polyisocyanate. The shell of the capsules may comprise a polymeric material that may be the reaction product of a polyisocyanate and a chitosan. The shell may comprise a polyurea resin, where the polyurea resin comprises the reaction product of a polyisocyanate and chitosan. The delivery particles of the present disclosure may be considered polyurea delivery particles and include a polyurea-chitosan shell. (As used herein, “shell” and “wall” are used interchangeably with regard to the delivery particles, unless indicated otherwise.) The shell may be derived from isocyanates and chitosan.

The polyurea-chitosan shell capsules may be made according to a process that comprises the following steps: forming a water phase comprising chitosan in an aqueous acidic medium; forming an oil phase comprising dissolving together perfume and at least one polyisocyanate; forming an emulsion by mixing under high shear agitation the water phase and the oil phase into an excess of the water phase, thereby forming droplets of the oil phase and perfume dispersed in the water phase; curing the emulsion by heating, for a time sufficient to form a shell at an interface of the droplets with the water phase, the shell comprising the reaction product of the polyisocyanate and chitosan, and the shell surrounding the core comprising the droplets of the oil phase and perfume. Diluents, for example isopropyl myristate, may be used to adjust the hydrophilicity of the oil phase. The oil phase is then added into the water phase and milled at high speed to obtain a targeted size. The emulsion is then cured in one or more heating steps.

The temperature and time are selected to be sufficient to form and cure a shell at the interface of the droplets of the oil phase with the water continuous phase. For example, the emulsion is heated to 85° C. in 60 minutes and then held at 85° C. for 360 minutes to cure the particles. The slurry is then cooled to room temperature.

Chitosan as a percentage by weight of the shell may be from about 21% up to about 95% of the shell. The ratio of the isocyanate monomer, oligomer, or prepolymer to chitosan may be up to 1:10 by weight.

The polyisocyanate may be an aliphatic or aromatic monomer, oligomer or prepolymer, usefully comprising two or more isocyanate functional groups. The polyisocyanate may preferably be selected from a group comprising toluene diisocyanate, a trimethylol propane adduct of toluene diisocyanate and a trimethylol propane adduct of xylylene diisocyanate, methylene diphenyl isocyanate, toluene diisocyanate, tetramethylxylidene diisocyanate, naphthalene-1,5-diisocyanate, and phenylene diisocyanate.

The polyisocyanate, for example, can be selected from aromatic toluene diisocyanate and its derivatives used in wall formation for encapsulates, or aliphatic monomer, oligomer or prepolymer, for example, hexamethylene diisocyanate and dimers or trimers thereof, or 3,3,5-trimethyl-5-isocyanatomethyl-1-isocyanato cyclohexane tetramethylene diisocyanate. The polyisocyanate can be selected from 1,3-diisocyanato-2-methylbenzene, hydrogenated MDI, bis(4-isocyanatocyclohexyl)methane, dicyclohexylmethane-4,4′-diisocyanate, and oligomers and prepolymers thereof. This listing is illustrative and not intended to be limiting of the polyisocyanates useful in the present disclosure.

The polyisocyanates useful in the disclosure comprise isocyanate monomers, oligomers or prepolymers, or dimers or trimers thereof, having at least two isocyanate groups. Optimal crosslinking can be achieved with polyisocyanates having at least three functional groups. Polyisocyanates, for purposes of the present disclosure, are understood as encompassing any polyisocyanate having at least two isocyanate groups and comprising an aliphatic or aromatic moiety in the monomer, oligomer, or prepolymer. If aromatic, the aromatic moiety can comprise a phenyl, a toluyl, a xylyl, a naphthyl or a diphenyl moiety, more preferably a toluyl or a xylyl moiety. Aromatic polyisocyanates, for purposes herein, can include diisocyanate derivatives such as biurets and polyisocyanurates. The polyisocyanate, when aromatic, can be, but is not limited to, methylene diphenyl isocyanate, toluene diisocyanate, tetramethylxylidene diisocyanate, polyisocyanurate of toluene diisocyanate (commercially available from Bayer under the tradename Desmodur® RC), trimethylol propane-adduct of toluene diisocyanate (commercially available from Bayer under the tradename Desmodur® L75), or trimethylol propane-adduct of xylylene diisocyanate (commercially available from Mitsui Chemicals under the tradename Takenate® D-110N), naphthalene-1,5-diisocyanate, and phenylene 5 diisocyanate.

There is a preference for aromatic polyisocyanate; however, aliphatic polyisocyanates and blends thereof may be useful. Aliphatic polyisocyanate is understood as a polyisocyanate which does not comprise any aromatic moiety. Aliphatic polyisocyanates include a trimer of hexamethylene diisocyanate, a trimer of isophorone diisocyanate, a trimethylol propane-adduct of hexamethylene diisocyanate (available from Mitsui Chemicals) or a biuret of hexamethylene diisocyanate (commercially available from Bayer under the tradename Desmodur® N 100).

The perfume capsules according to the present disclosure may be characterized by a volume-weighted median particle size from about 1 to about 100 microns, preferably from about 10 to about 100 microns, preferably from about 15 to about 50 microns, more preferably from about 20 to about 40 microns, even more preferably from about 20 to about 30 microns. Different particle sizes are obtainable by controlling droplet size during emulsification. The capsules may be coated with a polysaccharide-based cationic polymer, preferably the capsules are coated with chitosan.

### Core

The core may comprise from about 5% to about 100%, by weight of the core, of a perfume. The core may comprise from about 45% to about 95%, preferably from about 50% to about 80%, more preferably from about 50% to about 70%, by weight of the core, of the perfume.

The perfume may comprise an aldehyde-comprising benefit agent, a ketone-comprising benefit agent, or a combination thereof. Such aldehyde- or ketone-containing perfume raw materials, are known to provide preferred benefits, such as freshness benefits. The perfume may comprise at least about 20%, preferably at least about 25%, more preferably at least about 40%, even more preferably at least about 50%, by weight of the perfume, of aldehyde-containing benefit agents, ketone-containing benefit agents, or combinations thereof.

The term “perfume raw material” (or “PRM”) as used herein refers to compounds having a molecular weight of at least about 100 g/mol and which are useful in imparting an odor, fragrance, essence or scent, either alone or with other perfume raw materials. Typical PRMs comprise inter alia alcohols, ketones, aldehydes, esters, ethers, nitrites and alkenes, such as terpene. A listing of common PRMs can be found in various reference sources, for example, “Perfume and Flavor Chemicals”, Vols. I and II; Steffen Arctander Allured Pub. Co. (1994) and “Perfumes: Art, Science and Technology”, Miller, P. M. and Lamparsky, D., Blackie Academic and Professional (1994).

The PRMs may be characterized by their boiling points (B.P.) measured at the normal pressure (760 mm Hg), and their octanol/water partitioning coefficient (P), which may be described in terms of log P, determined according to the test method below. Based on these characteristics, the PRMs may be categorized as Quadrant I, Quadrant II, Quadrant III, or Quadrant IV perfumes, as described in more detail in U.S. Pat. No. 6,869,923. Suitable Quadrant I, II, III, and IV perfume raw materials are disclosed therein.

Perfume raw materials having a boiling point B.P. lower than about 250° C. and a log P lower than about 3 are known as Quadrant I perfume raw materials. Quadrant I perfume raw materials are preferably limited to less than 30% of the fragrance material.

The perfume may comprise perfume raw materials that have a log P of from about 2.5 to about 4. It is understood that other perfume raw materials may also be present in the fragrance.

The liquid composition may further comprise a free perfume. Without wishing to be bound by theory the presence of free perfume in combination with encapsulated perfume oil may provide a better balance of freshness delivery during the different stages of laundering of fabrics and the during the use of the fabrics.

Preferably the liquid composition has a pH of from 4 to 8, preferably from 6 to 8, as measured in a 10% weight solution in demineralized water at 20° C.

The liquid composition may further comprise a structuring agent to improve suspension of the perfume capsules.

### Polysaccharide-Based Cationic Polymer

The liquid composition according to the disclosure comprises from 0.01% to 5%, preferably from 0.03% to 5%, most preferably from 0.05% to 3% by weight of the composition of the polysaccharide-based cationic polymer. The polysaccharide can be freely added to the liquid composition or can be added as part of the capsules.

Polysaccharide-based cationic polymers are either natural polysaccharides or derived from chemical modification of a polysaccharide backbone to incorporate overall cationic charge to the polymer. In the present disclosure, various polysaccharide backbone can be used for chemical modification, including, but not limit to cellulose, starch, glycogen, guar, dextran, polyglucan, chitin, pectins, curdlan, xylose, Inulin, pullulan, locust bean gum, cassia gum, tamarind gum (xyloglucan), xanthan gum, amylose, amylopectin, scleroglucan and mixtures thereof.

Chitosan is a preferred polysaccharide-based cationic polymer for use herein. In particular, when the chitosan form part of the wall of the perfume capsules.

Preferably, the polysaccharide backbone described herein have a weight average molecular weight of from 5K to 2000K Daltons, more preferably from 10K to 1000K Daltons, more preferably from 20K to 600K Daltons, most preferably from 30K to 400K Daltons.

The cationic modified polysaccharide can be derived from chemical modification of the polysaccharide backbone mentioned above with at least one positively charged organic group. The positively charged organic group typically has at least one hydrogen atom substituted by a positively charged substitution group. The positively charged organic group may be further substituted by other substitution groups, such as hydroxyl groups (—OH), acyl group (—CO—R), etc.

The positively charged organic group can be independently connected to the polysaccharide backbone via various linkages, including, but not limited to, an ether (—O—) linkage, or an ester (—O—C═O—) linkage, or a carbamate

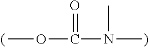

linkage.

The positively charged substitution group may be represented by structure below:

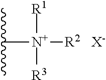

wherein, R¹, R² and R³ are each independently selected from a H; a linear or branched, substituted or non-substituted C₁-C₃₀ alkyl group, a substituted or non-substituted C₅-C₉ cycloalkyl group, a substituted or non-substituted C₆-C₃₀ arylalkyl group, or a substituted or non-substituted C₆-C₃₀ alkylaryl group. Preferably, at least one from R¹, R² and R³ is not H. More preferably, at least two from R¹, R² and R³ is not H. Most preferably, R¹, R² and R³ are each independently selected from a linear or branched C₁-C₂₀ alkyl group.

The X represents a counter ion for the positively charged organic group, the counter ion can be any suitable anion, including an acetate, bromide, carbonate, chloride, hydrogen carbonate, hydrogen phosphate, hydrogen sulfate, chloride (Cl⁻), ammonium based counterions including alkanolammonium ions preferable monethanolammonium ion.

A preferred example of positively charged organic group can be represented by the following structure:

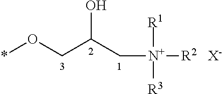

wherein, each of R¹, R² and R³ are independently selected from a linear or branched, substituted or non-substituted C₁ to C₁₈ alkyl. Preferably, R¹ and R² are both CH₃, and R³ is C₁₂-C₁₄ alkyl. More preferably, R¹, R² and R³ are all CH₃.

The “*” represent a carbon of the polysaccharide backbone. This positively charged organic group of Structure II comprises three carbon atoms (C₁, C₂ and C₃). One hydrogen atom on C₁ is substituted by a positively charged substitution group as defined herein. One hydrogen atom on C₂ is further substituted by a hydroxyl group (OH). The positively charged organic group is connected to a carbon of the polysaccharide backbone via C₃ through an ether linkage (—O—).

The X⁻ represent a counter ion for the positively charged organic group, and this counter ion can be any suitable anion, including an acetate, bromide, carbonate, chloride, hydrogen carbonate, hydrogen phosphate, hydrogen sulfate, preferably chloride (Cl⁻), ammonium based counterions including alkanolammonium ions preferable monethanolammonium ion.

Another preferred example of positively charged organic group can be represented by the following structure:

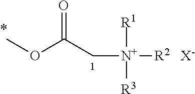

wherein, each of R¹, R² and R³ are each independently selected from a linear or branched, substituted or non-substituted C₁ to C₁₈ alkyl. Preferably, both R¹ and R² are CH₃, and R³ is C₁₂-C₁₄ alkyl. More preferably, R¹, R² and R³ are all CH₃.

The “*” represent a carbon of the polysaccharide backbone. This specific positively charged organic group (Structure III) comprises one carbon atoms (C₁). One hydrogen atom on C₁ is substituted by a positively charged substitution group as defined herein. The positively charged organic group is connected to a carbon of the polysaccharide backbone via C₁ through an ester linkage (—O—C—O—).

The X⁻ represents a counter ion for the positively charged organic group, the counter ion can be any suitable anion, including an acetate, bromide, carbonate, chloride, hydrogen carbonate, hydrogen phosphate, hydrogen sulfate, preferably chloride (Cl⁻), ammonium based counterions including alkanolammonium ions preferable monethanolammonium ion.

It is understood that R¹, R² and R³ in above structure (I), (II), (III) can be further substituted. For example, structure (IV) below can be considered as a specific class under Structure (III) with both R¹ and R² are CH₃, R³ is —CH₂CH₂CH₂—NH—(CO)—R⁴, wherein R⁴ is an alkyl group of C₁-C₁₈.

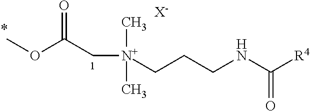

The positively charged organic group can derivatize the polysaccharide backbone at the 1, 2, 3, 4 and/or 6 positions of a glucose monomer in the backbone of the polysaccharide. Depending on reaction conditions and the specific substituent used to derivatize the polysaccharide, it is possible that the hydroxyl groups at certain glucose carbon positions may be disproportionately substituted due to steric hinderance and reactivity. For example, the hydroxyl at carbon position 6 for a branched unit may be more substituted than the hydroxyls at other carbon positions.

Depending on the reaction conditions and the specific substituent used to derivatize the polysaccharide backbone, certain glucose monomers on the backbone may be disproportionately substituted relative to other glucose monomers. Depending on reaction conditions and the specific substituent used, substitution of the polysaccharide may occur in a block manner.

The polysaccharide-based cationic polymers may comprise more than one type of positively charged organic group. In additional to the positively charged organic group, the polysaccharide-based cationic polymer may further comprise other function groups.

The average degree of substitution (DoS) of the positively charged group is preferably from about 0.01 (one cationic charge per 100 polymer repeating units) to about 3 (three cationic charges per polymer repeating unit), preferably from 0.03 to 2.0, more preferably from 0.05 to 1.0, and most preferably from 0.07 to 0.5. The term “degree of substitution” (DoS) as used herein refers to the average number of hydroxyl groups substituted in each monomeric unit (glucose) of a cationic polysaccharide.

One preferred family of polysaccharide-based cationic polymer is cationic modified cellulose. Suitable cationic modified celluloses include quaternized hydroxyethyl cellulose (Polyquaternium-10), which available under the tradename of Ucare by Dow Chemical, such as Ucare LR400, Ucare LR30M, Ucare JR125, Ucare JR400, etc. Suitable cationic modified cellulose polymers also include quaternised hydroxyethyl cellulose (HEC) polymers with cationic substitution of trimethyl ammonium and dimethyldodecyl ammonium (Polyquaternium-67), which available under trade the tradename of SoftCAT by Dow Chemical, such as SoftCAT SK, SoftCAT SK-MH, SoftCAT SX, SoftCAT SL. Other suitable cationic modified celluloses include those sold under tradename SupraCare™ by Dow Chemical, such as SupraCare™ 150, SupraCare™ 133, SupraCare™ 212, and polymer PK. Other suitable cationic modified cellulose polymers also include those modified with cationic group and/or a hydrophobic group and described as soil release polymers in WO2019111948, WO2019111949, WO2019111946 and WO2019111947. Suitable polymers may comprise more than one type of cationic modification, such as polymers disclosed in WO2022060754, WO2021242942 and WO2020/091988.

Suitable polysaccharide-based cationic polymer includes cationic modified dextran. Preferably, the cationic modified dextran is a dextran polymer functionalized with quaternary ammonium moieties; wherein the dextran polymer is a branched chain dextran polymer. More preferably, the cationic modified dextran is functionalized with quaternary ammonium moieties; wherein the dextran polymer comprises a branched chain dextran polymer; wherein the branched chain dextran polymer comprises a plurality of glucose structural units; wherein 90 to 98 mol % (preferably, 92.5 to 97.5 mol %; more preferably, 93 to 97 mol %; most preferably, 94 to 96 mol %) of the glucose structural units are connected by a-D-1,6 linkages and 2 to 10 mol % (preferably, 2.5 to 7.5 mol %; more preferably, 3 to 7 mol %, most preferably, 4 to 6 mol %) of the glucose structural units are connected by a-1,3 linkages. Most preferably, the cationic modified dextran is functionalized with quaternary ammonium moieties; wherein the dextran polymer is a branched chain dextran polymer; wherein the branched chain dextran polymer comprises a plurality of glucose structural units; wherein 90 to 98 mol % (preferably, 92.5 to 97.5 mol %; more preferably, 93 to 97 mol %; most preferably, 94 to 96 mol %) of the glucose structural units are connected by a-D-1,6 linkages and 2 to 10 mol % (preferably, 2.5 to 7.5 mol %; more preferably, 3 to 7 mol %; most preferably, 4 to 6 mol %) of the glucose structural units are connected by a-1,3 linkages. Suitable cationic modified dextran polymers are described in WO2021194808. Suitable cationic modified dextran polymers are also commercially available under brand name CDC, CDC-L, CDC-H from Meito Sangyo, which has CAS number of 83855-79-2.

Suitable polysaccharide-based cationic polymer also includes cationic modified polyglucans. Suitable cationic modified polyglucans are based on alpha 1,3-polyglucans and/or 1,6-polyglucans.

In one embodiment, the cationic modified polyglucan is a poly alpha-1,3-glucan ether compound comprising:
(i) poly alpha-1,3-glucan substituted with at least one positively charged organic group;
(ii) a weight average degree of polymerization of at least 6; and
(iii) a degree of substitution of about 0.05 to about 3.0;
wherein the poly alpha-1,3-glucan comprises a backbone of glucose monomer units, and wherein at least 50% of the glucose monomer units are linked via alpha-1,3-glycosidic linkages.

Suitable cationic modified poly alpha-1,6-glucan ether is also described in WO2015095358 and WO2021225837.

In another embodiment, the cationic modified polyglucan is a poly alpha-1,6-glucan ether compound comprising:
(i) poly alpha-1, 6-glucan substituted with at least one positively charged (ii) organic group;
(iii) a weight average degree of polymerization of at least 5; and
a degree of substitution of about 0.001 to about 3.0;
wherein the poly alpha-1,6-glucan comprises a backbone of glucose monomer units, and wherein at least 40% of the glucose monomer units are linked via alpha-1,6-glycosidic linkages.

Suitable cationic modified poly alpha-1,6-glucan ether is also described in WO2021/257786J, WO2021257793, WO2021257932.

In another embodiment, the cationic modified polyglucan is an ester derivative of a polyglucan, wherein the polyglucan has a degree of substitution (DoS) up to about 3.0 with at least one cationic organic group that is ester-linked to the polyglucan. Preferably, at least about 50% of the glycosidic linkages of the alpha-glucan are alpha-1,3-glycosidic linkages or alpha-1,6-glycosidic linkages. Suitable cationic modified poly glucan ester is described in WO2023/287684.

Another preferred family of polysaccharide-based cationic polymer is cationic modified guar. Suitable cationic modified guar include guar hydroxypropyltrimonium chloride, which available from by Ashland as AquaCat™ CG518 cationic solution, AquaCat™ PF618 cationic solution, N-Hance™ 3000, 3196, 3215, BF-13, BF-17, C261, C261N, CG13, CCG45. Other cationic modified guar polymers are available from Solvay as Jaguar® C 162, Excel, Excel SGI, Optima, C 13 S, C 13 SH, C14 S, C-17, LS SGI, C-500 STD. Other nonionic and/or anionic modified guar include for example Jaguar® HP 105 (Hydroxypropyl Guar gum), Jaguar® SOFT and HP-120 COS (Carboxymethyl Hydroxypropyl Guar Gum).

Another preferred family of polysaccharide-based cationic polymer is cationic modified inulin. “inulins” are understood to comprise polysaccharides comprising β-(2,1) linked fructofuranose units and a glucopyranose unit. The degree of polymerization ranges preferably between 2 and 60. Inulin can for example be obtained from chicory, dahlias and Jerusalem artichokes. Example of cationic modified inulin are as described in US20190274943, US20180119055. Suitable cationic modified inulin are Quatin series sold by Cosun Beet Company, including Quatin 350, Quatin 380 and Quatin 1280 which are characterized by different degree of substitution (DS), cationic density (meq/g) and molecular weight (g/mol).

Suitable polysaccharide-based cationic polymer includes cationic modified starch.

Chitosan is specially preferred for use in the composition of the disclosure. In particular, it has been found that perfume capsules coated with chitosan improve the olfactory experience provided by the composition of the disclosure.

Chitosan is a linear polysaccharide comprising randomly distributed β-(1,4)-linked D-glucosamine (deacetylated unit) and N-acetylglucosamine (acetylated unit) and generally has the following structure:

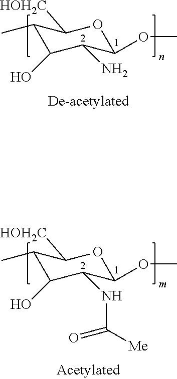

$$\% Deacetylation = 100 n / ( n + m )$$

wherein n and m vary depending on the average molecular weight of the chitosan and the degree of deacetylation of the chitosan. The degree of deacetylation (% deacetylation) of the chitosan is equal to 100n/(n+m).

The solubility of chitosan in pH buffer solution is typically affected by the degree of deacetylation of the chitsoan and the weight average molecular weight of the chitosan. The degree of deacetylation of the chitosan can be determined according to the DEGREE OF DEACETYLATION TEST METHOD hereinbelow. The weight average molecular weight of the chitosan can be determined according to the MOLECULAR WEIGHT TEST METHOD hereinbelow.

Preferably, the chitosan of the present disclosure has a weight average molecular weight of at least about 100 kDa (kilodaltons) and/or a degree of deacetylation of at least about 60%.

The chitosan of the present disclosure can have lower degree of deacetylation values, if the chitosan has relatively higher weight average molecular weight. The chitosan may also have lower weight average molecular weight values, if the chitosan has relatively higher degree of deacetylation values. Preferred chitosans have degree of deacetylation values and weight average molecular weight values that are both relatively high, which tend to exhibit lower solubility in pH buffer solution across the pH range of 2-10.

The chitosan can have a degree of deacetylation of at least about 60% and a weight average molecular weight of at least about 10 kDa.

The chitosan can have a weight average molecular weight of at least about 100 kDa and a degree of deacetylation of at least about 50%.

Chitosan suitable for use herein can have either: (i) a weight average molecular weight of at least about 500 kDa and a degree of de-acetylation of at least about 50%, or (ii) a weight average molecular weight of at least about 10 kDa and a degree of de-acetylation of at least about 70%.

Preferably, the chitosan has a degree of deacetylation of at least about 60%, preferably at least about 70%, and preferably at least about 75%.

Preferably, the chitosan has a weight average molecular weight of at least about 100 kDa, preferably at least about 200 kDa, and preferably at least about 400 kDa.

The amine group of chitosan has a pKₐ of about 6.5 and results in protonation of the chitosan in acidic to neutral solutions, with the charge density largely dependent upon the degree of deacetylation of the chitosan and the pH of solution. As such, chitosan is typically cationic and can readily bind to anionically charged surfaces.

The chitosan is generally disposed on the outer surface of the capsules, preferably on polyacrylate capsules. The chitosan tends to adhere to the outer surface of capsules due to the anionically charged outer surface of the polyacrylate capsules through the protonated amino groups of the chitosan to form a gel. When used in a laundry application, such as treating fabrics in a typical wash/rinse solution and process, the gel tends to become more hydrophobic based on the increased pH of the wash/rinse solution due to de-protonation of the amino group. These hydrophobic gels tend to more effectively deposit and adhere to the treated surfaces, such as the treated fibers of a fabric, thereby increasing the deposition of the chitosan-coated capsules versus capsules that are not coated with chitosan.

The chitosan is combined with the capsules, thereby becoming disposed on the outer surface of the capsules, before the capsules are combined with the remaining ingredients of the liquid composition of the disclosure. When the composition of the disclosure comprises capsules coated with chitosan the level of chitosan is preferable from 0.01 to 5%, more preferably from 0.01% to 3%, most preferably from 0.03% to 1% by weight of the liquid composition of chitosan.

Suitable structuring agents include polyacrylate based polymers, preferably hydrophobically modified polyacrylate polymers; hydroxyl ethyl cellulose, preferably hydrophobically modified hydroxyl ethyl cellulose, xanthan gum, hydrogenated castor oil (HCO), and mixtures thereof.

Preferred hydrophobically modified polyacrylate polymers include water soluble copolymers based on main monomers acrylic acid, acrylic acid esters, vinyl acetate, methacrylic acid, acrylonitrile and mixtures thereof, more preferably the copolymer is based on methacrylic acid and acrylic acid esters having appearance of milky, low viscous dispersion. Most preferred hydrologically modified polyacrylate polymer is Rheovis® AT 120, which is commercially available from BASF.

Other suitable structurants are hydroxyethylcelluloses (HM-HEC) preferably hydrophobically modified hydroxyethylcellulose. Suitable hydroxyethylcelluloses (HM-HEC) are commercially available from Aqualon/Hercules under the product name Polysurf 76® and W301 from 3V Sigma.

Xanthan gum is one suitable structurant used herein. Xanthan gum is a polysaccharide commonly used rheology modifier and stabilizer. Xanthan gum is produced by fermentation of glucose or sucroce by the Xanthomonas campestris bacterium. Suitable Xanthan gum is commercially available under trade anem Kelzan T® from CP Kelco.

Suitable hydrogenated castor oil is available under trade name THIXCIN® from Elementis. Other suitable structurants include Alkali Soluble Emulsion (ASE), or a Hydrophobically Modified Alkali Soluble Emulsion (HASE). ASE and HASE polymers suitable for use herein are described in WO 2024/055047A1.

The liquid composition may further comprise aesthetical dyes and/or pigments, hueing dyes, opacifying agents, and/or mixtures thereof.

Preferably the liquid composition is free or essentially free of anionic surfactant and charged polymers. Without wishing to be bound by theory such ingredients are believed to compromise the leakage prevention impact of the alkoxylated alcohol nonionic surfactants according to the disclosure.

### Method of Making the Composition of the Disclosure

The composition of the disclosure can be made by adding the polysaccharide-based cationic polymer to an aqueous composition before or after adding the nonionic material and the perfume capsules. Alternatively, the composition of the disclosure can be made by adding the polysaccharide-based cationic polymer as part of the perfume capsules.

### Unit-Dose Article

The present disclosure also relates to a unit-dose article. The unit-dose article comprises a water-soluble film which encompasses an inner volume enclosed by the water-soluble film. The inner volume houses the liquid composition of the disclosure.

Multiple compartments, also referred to herein as multi-compartment, unit-dose articles comprise two or more compartments. Preferably, the unit-dose article has at least two compartments, the first compartment housing the composition of the disclosure (first composition) and the second compartment housing a composition comprising a surfactant and a cleaning adjunct (second composition).

The water-soluble film is sealed such that the composition does not leak out of the compartments during storage. However, upon addition of the water-soluble unit-dose article to water, the water-soluble film dissolves and releases the contents of the internal compartment into water.

Each compartment should be understood as meaning a closed internal space within the unit-dose article, which holds a composition. The unit-dose article is manufactured such that the water-soluble film completely surrounds a composition and in doing so defines the compartment in which the composition resides. The film is described in more detail below.

The unit-dose article can comprise one or more compartments, two or even at least three compartments, or even at least four compartments, in which preferably at least two compartments are present in a superposed position, i.e. one positioned on top of the other. The unit-dose article may further comprise compartments positioned in a side-by-side orientation, i.e. one orientated next to one another, or even be orientated in a ‘tyre and rim’ arrangement, i.e. a first compartment is positioned next to a second compartment, but the first compartment at least partially surrounds the second compartment, but does not completely enclose the second compartment, or alternatively, one compartment may be completely enclosed within another compartment.

One of the compartments may be smaller than the other compartment. Wherein the unit-dose article comprises at least three compartments, two of the compartments may be smaller than the third compartment, and preferably the smaller compartments are superposed on the larger compartment. Wherein the unit-dose article comprises at least four compartments, three of the compartments may be smaller than the fourth compartment, and preferably the smaller compartments are superposed on the larger compartment. The superposed compartments preferably are orientated side-by-side.

The water-soluble film comprises an inner surface which is in contact with a composition and an outer surface which is oriented away from the composition, towards the outside environment.

Preferably the water-soluble unit-dose article comprises one larger compartment with at least one, preferably at least two, or even at least three smaller compartments superposed thereon. Preferably the first composition is housed in a smaller compartment (first compartment) and the second composition is housed in a larger compartment (second compartment).

The outer contouring seal area includes or preferably consists of a flange area. A flange area is arranged around the perimeter of the unit-dose article, and the flange comprises sealed film from two, three, or more water-soluble films. In other words, the flange area protrudes out from the unit-dose article and comprises sealed film. By ‘seal area’ we herein mean both the inner seal area as defined as the areas of film sealed together to define the individual compartments without the presence of a flange as well as the outer seal area defining a flange of the water-soluble unit-dose article. Herein the flange excludes the inner seal areas. Preferably, the flange comprises sealed film from at least a first water-soluble film and a second water-soluble film and a third water-soluble film if present. The inner seal area can be created by sealing two water-soluble films together to create physically separated individual compartments or can be created by sealing at least three films together to create physically separated individual compartments. Preferably the inner seal is created by sealing solely two water-soluble films together.

### Water-Soluble Film

The film of the unit-dose article of the present disclosure is soluble or dispersible in water. The water-soluble film preferably has a thickness prior to deformation of from 20 to 150 micron, preferably 35 to 125 micron, even more preferably 50 to 110 micron, most preferably about 76 micron.

Preferably, the film has a water-solubility of at least 50%, preferably at least 75% or even at least 95%, as measured by the method set out here after using a glass-filter with a maximum pore size of 20 microns:
5 grams±0.1 gram of film material is added in a pre-weighed 3 L beaker and 2 L*5 ml of distilled water is added. This is stirred vigorously on a magnetic stirrer, Labline model No. 1250 or equivalent and 5 cm magnetic stirrer, set at 600 rpm, for 30 minutes at 30° C. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction).

Then, the percentage solubility or dispersability can be calculated.

Preferred film materials are preferably polymeric materials. The film material can, for example, be obtained by casting, blow-moulding, extrusion or blown extrusion of the polymeric material, as known in the art.

The water-soluble film comprises polyvinyl alcohol polymer wherein the polyvinyl alcohol polymer comprises a polyvinyl alcohol homopolymer, an anionic polyvinyl alcohol copolymer, or a blend thereof, preferably wherein the anionic polyvinylalcohol copolymers are selected from sulphonated and carboxylated anionic polyvinylalcohol copolymers especially carboxylated anionic polyvinylalcohol copolymers. Most preferably the water-soluble film comprises a blend of polyvinyl alcohol homopolymers, a blend of a polyvinylalcohol homopolymer and a carboxylated anionic polyvinylalcohol copolymer, or alternatively, the polyvinylalcohol consists of an anionic polyvinyl alcohol copolymer, most preferably a carboxylated anionic polyvinylalcohol copolymer. When the polyvinylalcohol in the water-soluble film is a blend of a polyvinylalcohol homopolymer and a carboxylated anionic polyvinylalcohol copolymer, the homopolymer and the anionic copolymer are present in a relative weight ratio of 90/10 to 10/90, preferably 80/20 to 20/80, more preferably 70/30 to 50/50. General classes of anionic monomer units which can be used for the anionic polyvinyl alcohol co-polymer include the vinyl polymerization units corresponding to monocarboxylic acid vinyl monomers, their esters and anhydrides, dicarboxylic monomers having a polymerizable double bond, their esters and anhydrides, vinyl sulfonic acid monomers, and alkali metal salts of any of the foregoing. Examples of suitable anionic monomer units include the vinyl polymerization units corresponding to vinyl anionic monomers including vinyl acetic acid, maleic acid, monoalkyl maleate, dialkyl maleate, monomethyl maleate, dimethyl maleate, maleic anyhydride, fumaric acid, monoalkyl fumarate, dialkyl fumarate, monomethyl fumarate, dimethyl fumarate, fumaric anyhydride, itaconic acid, monomethyl itaconate, dimethyl itaconate, itaconic anhydride, vinyl sulfonic acid, allyl sulfonic acid, ethylene sulfonic acid, 2-acrylamido-1-methylpropanesulfonic acid, 2-acrylamido-2-methylpropanesulfonic acid, 2-methylacrylamido-2-methylpropanesulfonic acid, 2-sufoethyl acrylate, alkali metal salts of the foregoing (e.g., sodium, potassium, or other alkali metal salts), esters of the foregoing (e.g., methyl, ethyl, or other C1-C4 or C6 alkyl esters), and combinations thereof (e.g., multiple types of anionic monomers or equivalent forms of the same anionic monomer). The anionic monomer may be one or more acrylamido methylpropanesulfonic acids (e.g., 2-acrylamido-1-methylpropanesulfonic acid, 2-acrylamido-2-methylpropanesulfonic acid, 2-methylacrylamido-2-methylpropanesulfonic acid), alkali metal salts thereof (e.g., sodium salts), and combinations thereof. Preferably, the anionic moiety of the first anionic monomer unit is selected from a sulphonate, a carboxylate, or a mixture thereof, more preferably a carboxylate, most preferably an acrylate, a methacrylate, a maleate, or a mixture thereof. Preferably, the anionic monomer unit is present in the anionic polyvinyl alcohol copolymer in an average amount in a range of between 1 mol. % and 5 mol. % or between 2 mol. % and 5 mol. %.

The polyvinyl alcohol polymer may be present between 50% and 95%, preferably between 55% and 90%, more preferably between 60% and 80% by weight of the water-soluble film. Without wishing to be bound by theory, the term “homopolymer” generally includes polymers having a single type of monomeric repeating unit (e.g., a polymeric chain comprising or consisting of a single monomeric repeating unit). For the particular case of polyvinyl alcohol, the term “homopolymer” further includes copolymers having a distribution of vinyl alcohol monomer units and optionally vinyl acetate monomer units, depending on the degree of hydrolysis (e.g., a polymeric chain comprising or consisting of vinyl alcohol and vinyl acetate monomer units). In the case of 100% hydrolysis, a polyvinyl alcohol homopolymer can include only vinyl alcohol units.

Without wishing to be bound by theory, the term “copolymer” generally includes polymers having two or more types of monomeric repeating units (e.g., a polymeric chain comprising or consisting of two or more different monomeric repeating units, whether as random copolymers, block copolymers, etc.). For the particular case of polyvinyl alcohol, the term “copolymer” (or “polyvinyl alcohol copolymer”) further includes copolymers having a distribution of vinyl alcohol monomer units and vinyl acetate monomer units, depending on the degree of hydrolysis, as well as at least one other type of monomeric repeating unit (e.g., a ter-(or higher) polymeric chain comprising or consisting of vinyl alcohol monomer units, vinyl acetate monomer units, and one or more other monomer units, for example anionic monomer units). In the case of 100% hydrolysis, a polyvinyl alcohol copolymer can include a copolymer having vinyl alcohol units and one or more other monomer units, but no vinyl acetate units. Without wishing to be bound by theory, the term “anionic copolymer” includes copolymers having an anionic monomer unit comprising an anionic moiety.

Preferably, the polyvinyl alcohol, and/or in case of polyvinyl alcohol blends the individual polyvinyl alcohol polymers and/or the combined polyvinyl alcohol polymers, have an average viscosity (μ1) in a range of between 4 mPa·s and 30 mPa·s, preferably between 10 mPa·s and 25 mPa·s, measured as a 4% polyvinyl alcohol polymer solution in demineralized water at 20 degrees C. The viscosity of a polyvinyl alcohol polymer is determined by measuring a freshly made solution using a Brookfield LV type viscometer with UL adapter as described in British Standard EN ISO 15023-2:2006 Annex E Brookfield Test method. It is international practice to state the viscosity of 4% aqueous polyvinyl alcohol solutions at 20° C. It is well known in the art that the viscosity of an aqueous water-soluble polymer solution (polyvinylalcohol or otherwise) is correlated with the weight-average molecular weight of the same polymer, and often the viscosity is used as a proxy for weight-average molecular weight. Thus, the weight-average molecular weight of the polyvinylalcohol can be in a range of 30,000 to 175,000, or 30,000 to 100,000, or 55,000 to 80,000. Preferably, the polyvinyl alcohol, and/or in case of polyvinylalcohol blends the individual polyvinylalcohol polymers, have an average degree of hydrolysis in a range of between 75% and 99%, preferably between 80% and 95%, most preferably between 85% and 95%. A suitable test method to measure the degree of hydrolysis is as according to standard method JIS K6726.

Alternative the water-soluble film may comprise a water-soluble resin comprising or consisting of a biopolymer or bio-derived polymer.

Preferably, the water-soluble film comprises a non-aqueous plasticizer. Preferably, the non-aqueous plasticizer is selected from polyols, sugar alcohols, and mixtures thereof. Suitable polyols include polyols selected from the group consisting of glycerol, diglycerin, ethylene glycol, diethylene glycol, triethyleneglycol, tetraethylene glycol, polyethylene glycols up to 400 molecular weight, neopentyl glycol, 1,2-propylene glycol, 1,3-propanediol, dipropylene glycol, polypropylene glycol, 2-methyl-1,3-propanediol, trimethylolpropane and polyether polyols, or a mixture thereof. Suitable sugar alcohols include sugar alcohols selected from the group consisting of isomalt, maltitol, sorbitol, xylitol, erythritol, adonitol, dulcitol, pentaerythritol and mannitol, or a mixture thereof. More preferably the non-aqueous plasticizer is selected from glycerol, propylene glycol, dipropylene glycol, 2-methyl-1,3-propanediol, trimethylolpropane, triethyleneglycol, polyethyleneglycol, sorbitol, or a mixture thereof, most preferably selected from glycerol, sorbitol, trimethylolpropane, dipropylene glycol, and mixtures thereof. One particularly suitable plasticizer system includes a blend of glycerol, sorbitol and trimethylol propane. Another particularly suitable plasticizer system includes a blend of glycerin, dipropylene glycol, and sorbitol. Preferably, the film comprises between 5% and 50%, preferably between 10% and 40%, more preferably between 20% and 30% by weight of the film of the non-aqueous plasticizer. Preferably, the water-soluble film comprises a surfactant. Preferably, the water-soluble film comprises a surfactant in an amount between 0.1% and 2.5%, preferably between 1% and 2% by weight of the water-soluble film. Suitable surfactants can include the nonionic, cationic, anionic and zwitterionic classes. Suitable surfactants include, but are not limited to, polyoxyethylenated polyoxypropylene glycols, alcohol ethoxylates, alkylphenol ethoxylates, tertiary acetylenic glycols and alkanolamides (nonionics), polyoxyethylenated amines, quaternary ammonium salts and quaternized polyoxyethylenated amines (cationics), and amine oxides, N-alkylbetaines and sulfobetaines (zwitterionics). Other suitable surfactants include dioctyl sodium sulfosuccinate, lactylated fatty acid esters of glycerol and propylene glycol, lactylic esters of fatty acids, sodium alkyl sulfates, polysorbate 20, polysorbate 60, polysorbate 65, polysorbate 80, lecithin, acetylated fatty acid esters of glycerol and propylene glycol, and acetylated esters of fatty acids, and combinations thereof.

Preferably the water-soluble film according to the disclosure comprises lubricants/release agents. Suitable lubricants/release agents can include, but are not limited to, fatty acids and their salts, fatty alcohols, fatty esters, fatty amines, fatty amine acetates and fatty amides. Preferred lubricants/release agents are fatty acids, fatty acid salts, and fatty amine acetates. The amount of lubricant/release agent in the water-soluble film is in a range of from 0.02% to 1.5%, preferably from 0.1% to 1% by weight of the water-soluble film.

Preferably, the water-soluble film comprises fillers, extenders, antiblocking agents, detackifying agents or a mixture thereof. Suitable fillers, extenders, antiblocking agents, detackifying agents or a mixture thereof include, but are not limited to, starches, modified starches, crosslinked polyvinylpyrrolidone, crosslinked cellulose, microcrystalline cellulose, silica, metallic oxides, calcium carbonate, talc and mica. Preferred materials are starches, modified starches and silica. Preferably, the amount of filler, extender, antiblocking agent, detackifying agent or mixture thereof in the water-soluble film is in a range of from 0.1% to 25%, preferably from 1% to 10%, more preferably from 2% to 8%, most preferably from 3% to 5% by weight of the water-soluble film. In the absence of starch, one preferred range for a suitable filler, extender, antiblocking agent, detackifying agent or mixture thereof is from 0.1% to 1%, preferably 4%, more preferably 6%, even more preferably from 1% to 4%, most preferably from 1% to 2.5%, by weight of the water-soluble film.

Preferably the water-soluble film according to the disclosure has a residual moisture content of at least 4%, more preferably in a range of from 4% to 15%, even more preferably of from 5% to 10% by weight of the water-soluble film as measured by Karl Fischer titration.

Preferred films exhibit good dissolution in cold water, meaning unheated distilled water. Preferably such films exhibit good dissolution at temperatures of 24° C., even more preferably at 10° C. By good dissolution it is meant that the film exhibits water-solubility of at least 50%, preferably at least 75% or even at least 95%, as measured by the method set out here after using a glass-filter with a maximum pore size of 20 microns, described above.

The film may be opaque, transparent or translucent. Preferably, the film is transparent. The film may comprise a printed area.

The area of print may be achieved using standard techniques, such as flexographic printing or inkjet printing.

The film may comprise an aversive agent, for example a bittering agent. Suitable bittering agents include, but are not limited to, naringin, sucrose octaacetate, quinine hydrochloride, denatonium benzoate, or mixtures thereof. Any suitable level of aversive agent may be used in the film. Suitable levels include, but are not limited to, 1 to 5000 ppm, or even 100 to 2500 ppm, or even 250 to 2000 rpm.

The water-soluble film or water-soluble unit-dose article or both may be further coated in a lubricating agent, preferably, wherein the lubricating agent is selected from talc, zinc oxide, silicas, siloxanes, zeolites, silicic acid, alumina, sodium sulphate, potassium sulphate, calcium carbonate, magnesium carbonate, sodium citrate, sodium tripolyphosphate, potassium citrate, potassium tripolyphosphate, calcium stearate, zinc stearate, magnesium stearate, starch, modified starches, clay, kaolin, gypsum, cyclodextrins or mixtures thereof.

### Second Composition

The second composition is preferably a liquid composition. The composition is preferably part of a detergent composition. More preferably part of an automatic dishwashing or laundry detergent composition. More preferably part of a liquid laundry detergent composition.

The term ‘liquid laundry detergent composition’ refers to any laundry detergent composition comprising a liquid capable of wetting and treating a fabric, and includes, but is not limited to, liquids, gels, pastes, dispersions and the like. The liquid composition can include solids or gases in suitably subdivided form, but the liquid composition excludes forms which are non-fluid overall, such as tablets or granules.

The laundry detergent composition can be used in a fabric hand wash operation or may be used in an automatic machine fabric wash operation.

Preferably, the second composition comprises a non-soap surfactant. The non-soap surfactant is preferably selected from non-soap anionic surfactant, non-ionic surfactant or a mixture thereof. Preferably, the laundry detergent composition comprises between 10% and 60%, more preferably between 20% and 55% by weight of the laundry detergent composition of the non-soap surfactant. Example weight ratio of non-soap anionic surfactant to nonionic surfactant are from 1:1 to 20:1, from 1.25:1 to 17.5:1, from 1.5:1 to 15:1, or from 1.75:1 to 13:1.

Preferably, the anionic non-soap surfactant comprises linear alkylbenzene sulphonate, alkyl sulphate, alkoxylated alkyl sulphate or a mixture thereof. Preferably, the alkoxylated alkyl sulphate is an ethoxylated alkyl sulphate.

Preferably, the second composition comprises between 5% and 60%, preferably between 15% and 55%, more preferably between 25% and 50%, most preferably between 30% and 45% by weight of the composition of the non-soap anionic surfactant.

Preferably, the non-soap anionic surfactant comprises linear alkylbenzene sulphonate and alkoxylated alkyl sulphate, wherein the ratio of linear alkylbenzene sulphonate to alkoxylated alkyl sulphate preferably the weight ratio of linear alkylbenzene sulphonate to ethoxylated alkyl sulphate is from 1:2 to 9:1, preferably from 1:1 to 7:1, more preferably from 1:1 to 5:1, even more preferably from 1:1 to 4:1. Alternatively the non-soap anionic surfactant can consist of linear alkylbenzene sulphonate. Alternatively the non-soap anionic surfactant can comprise unalkoxylated alkyl sulphate and linear alkylbenzene sulphonate. The alkoxylated or unalkoxylated alkyl sulphate can be derived from a synthetic alcohol or a natural alcohol, or from a blend thereof, pending the desired average alkyl carbon chain length and average degree of branching. Preferably, the synthetic alcohol is made following the Ziegler process, OXO-process, modified OXO-process, the Fischer Tropsch process, Guerbet process or a mixture thereof. Preferably, the naturally derived alcohol is derived from natural oils, preferably coconut oil, palm kernel oil or a mixture thereof. Preferably, the laundry detergent composition comprises between 1% and 30%, preferably between 2% and 25%, most preferably between 3% and 20% by weight of the laundry detergent composition of a non-ionic surfactant. The non-ionic surfactant is preferably selected from alcohol alkoxylate, Ziegler-synthesized alcohol alkoxylate, an oxo-synthesized alcohol alkoxylate, Guerbet alcohol alkoxylates, alkyl phenol alcohol alkoxylates or a mixture thereof.

Preferably, the second composition comprises between 1.5% and 20%, more preferably between 2% and 15%, even more preferably between 3% and 10%, most preferably between 4% and 8% by weight of the composition of soap, preferably a fatty acid salt, more preferably an amine neutralized fatty acid salt, wherein preferably the amine is an alkanolamine more preferably selected from monoethanolamine, diethanolamine, triethanolamine or a mixture thereof, more preferably monoethanolamine.

Preferably, the second composition comprises a non-aqueous solvent, preferably wherein the non-aqueous solvent is selected from propylene glycol, dipropylene glycol, tripropyleneglycol, glycerol, sorbitol, polyethyleneglyceol, polypropylene glycol, or a mixture thereof, preferably wherein the polypropyleneglycol has a molecular weight of 400. Preferably the second composition comprises between 10% and 40%, preferably between 15% and 30% by weight of the composition of the non-aqueous solvent. Without wishing to be bound by theory the non-aqueous solvents ensure appropriate levels of film plasticization so the film is not too brittle and not too ‘floppy’. Without wishing to be bound by theory, having the correct degree of plasticization will also facilitate film dissolution when exposed to water during the wash process.

Preferably, the second composition comprises between 0.5% and 15%, preferably between 5% and 13% by weight of the composition of water.

Preferably, the second composition comprises an ingredient selected from the list comprising cationic polymers, polyester terephthalates, amphiphilic graft co-polymers, carboxymethylcellulose, enzymes, perfumes, encapsulated perfumes, bleach or a mixture thereof.

The laundry detergent composition may comprise an adjunct ingredient, wherein the adjunct ingredient is selected from ethanol, hueing dyes, aesthetic dyes, enzymes, builders preferably citric acid, chelants, cleaning polymers, dispersants, dye transfer inhibitor polymers, fluorescent whitening agent, opacifier, antifoam, preservatives, anti-oxidants, or a mixture thereof. Preferably the chelant is selected from aminocarboxylate chelants, aminophosphonate chelants, or a mixture thereof.

Preferably, the second composition has a pH between 6 and 10, more preferably between 6.5 and 8.9, most preferably between 7 and 8, wherein the pH of the laundry detergent composition is measured as a 10% by weight solution in demineralized water at 20° C.

The second composition may be Newtonian or non-Newtonian. Preferably, the second composition is non-Newtonian. Without wishing to be bound by theory, a non-Newtonian liquid has properties that differ from those of a Newtonian liquid, more specifically, the viscosity of non-Newtonian liquids is dependent on shear rate, while a Newtonian liquid has a constant viscosity independent of the applied shear rate. The decreased viscosity upon shear application for non-Newtonian liquids is thought to further facilitate dissolution. The second composition described herein can have any suitable viscosity depending on factors such as formulated ingredients and purpose of the composition. When Newtonian the composition may have a viscosity value, at a shear rate of 20 s−1 and a temperature of 20° C., of 100 to 3,000 cP, alternatively 200 to 2,000 cP, alternatively 300 to 1,000 cP, following the method described herein. When non-Newtonian, the composition may have a high shear viscosity value, at a shear rate of 20 s−1 and a temperature of 20° C., of 100 to 3,000 cP, alternatively 300 to 2,000 cP, alternatively 500 to 1,000 cP, and a low shear viscosity value, at a shear rate of 1 s−1 and a temperature of 20° C., of 500 to 100,000 cP, alternatively 1000 to 10,000 cP, alternatively 1,300 to 5,000 cP, following the method described herein. Methods to measure viscosity are known in the art. According to the present disclosure, viscosity measurements are carried out using a rotational rheometer e.g. TA instruments AR550.

The instrument includes a 40 mm 2° or 1° cone fixture with a gap of around 50-60μιη for isotropic liquids, or a 40 mm flat steel plate with a gap of 1000 μm for particles containing liquids. The measurement is carried out using a flow procedure that contains a conditioning step, a peak hold and a continuous ramp step. The conditioning step involves the setting of the measurement temperature at 20° C., a pre-shear of 10 seconds at a shear rate of 10 s−1, and an equilibration of 60 seconds at the selected temperature. The peak hold involves applying a shear rate of 0.05 s−1 at 20° C. for 3 min with sampling every 10 s. The continuous ramp step is performed at a shear rate from 0.1 to 1200 s−1 for 3 min at 20° C. to obtain the full flow profile.

### Test Methods

### Molecular Weight Test Method

The following test method is used to determine the weight average molecular weight of the chitosan.

Size-exclusion liquid chromatography (LC) is used to determine the Weight-Average Molecular Weight of chitosan test material. Chitosan samples (0.1% wt/vol) are dissolved in AcOH/AcNH4 buffer (pH 4.5) and then filtered through a 0.45 μm pore size membrane (Millipore). Size-exclusion liquid chromatography (LC) is performed by means of an LC pump (such as the 1260 Infinity pump, Agilent Technologies, Santa Clara, California, USA), with two serially-connected columns specifically a model TSK G2500-PW column and a model TSK G6000-PW column, both available from Tosoh Bioscience LLC (King of Prussia, Pennsylvania, USA). The detection is achieved via a differential refractometer (such as the model Wyatt Optilab T-rex) coupled on-line with a MALLS detector (such as the model Wyatt Dawn Heleos II) both available from Wyatt Technology Corp. (Santa Barbara, California, USA.). Degassed AcOH/AcNH4 buffer (pH 4.5) is used as the eluent after two filtrations through 0.22 μm pore size membranes (Millipore). The flow rate is maintained at 0.5 mL/min, and the amount of sample injected is 100 ul. Chromatograms are analyzed by the software such as the Wyatt Astra version 6.1.2 (Wyatt Technology Corp., Santa Barbara, California, USA) to calculate the Weight Average Molecular Weight of the chitosan test material.

### Degree of Deacetylation Test Method

The following test method is used to determine the degree of deacetylation of chitosan.

The degree of deacetylation of chitosan test material is determined via Nuclear Magnetic Resonance (NMR) spectroscopy. Chitosan test material (10 mg) is dissolved in 1 mL of dilute acidic D₂O (>99.9%, such as available from Aldrich). A Brüker NMR instrument model DRX 300 spectrometer (300 MHz) (Bruker Corp., Billerica, Massachusetts, USA) or similar instrument is used to measure the 1H NMR at 298 Kelvin. The 1H chemical shifts are expressed from the signal of 3-(trimethylsilyl) propionic-2,2,3,3-d4 acid sodium salt (>98%, such as available from Aldrich) which is used as an external reference. The degree of deacetylation is calculated from the measured chemical shifts according to standard and widely used approach described in the publication: Hirai et al., Polymer Bulletin 26 (1991), 87-94.

### Examples

### Wash Test

Terry cotton fabrics (four terry cotton fabrics of 30×30 cm), together with a cotton ballast load forming a laundry load of 3.0 kg were washed in a Miele W1714 washing machine at 30° C., 2 rinse cycles, with a total cycle time of 1 hr 50 minutes. The water hardness was 15 gpg. After washing, the terry cotton tracers were line-dried during 1 day in a controlled humidity chamber at 20-25° C. with 60% relative humidity.

### Head Space Analysis

The washed cotton fabric was analyzed by a fast head space GC/MS (gas chromatography mass spectrometry). A 4×4 cm piece was cut out the washed terry fabric and was transferred to 25 ml head space vials. The fabric sample was equilibrated for 10 minutes at 65° C. The head space above the fabrics was sampled via SPME (50/30 μm DVB/Carboxen/PDMS) for 5 minutes.

The SPME fiber was subsequently on-line thermally desorbed into the GC. The analytes were analyzed by fast GC/MS in full scan mode. Ion extraction of the specific masses of the perfume raw materials (PRM) was used to calculate the total head space concentration above the tested legs. For each wash test, 4 replicates were measured. The reported head space concentration (HS) is the average of the 4 replicates, indexed versus a reference product.

### Perfume Capsules

To a 1 L capacity water jacketed stainless steel reactor, 143.12 grams of perfume oil and 168.6 grams of isopropyl myristate were added and allowed to mix with the aid of a high shear mixer fitted with a mill blade, under a nitrogen environment. The solution was heated to 35° C. before introducing 0.33 grams of Vazo67 (2,2′-azobis(methylbutyronitrile) initiator) and the total mixture was subsequently heated to 70° C. and was maintained at that temperature for 45 minutes before cooling the system down to 50° C. As soon as the temperature was reached, a solution, prepared separately, containing 63.05 grams of perfume oil, 0.075 grams of CD9055 (acidic acrylate), 0.075 grams of TBAEMA (tert-Butylaminoethyl Methacrylate), and 6.23 grams of CN975 (hexafunctional aromatic urethane oligomer) was introduced into the reactor and the total mixture was allowed to mix for 10 min while at 50° C. The water phase, consisting of 107 grams of emulsifier (5% solution of Polyvinyl alcohol 540 wherein the Polyvinyl alcohol 540 has about 88 mol % degree of hydrolysis and viscosity of 50 cP as a 4 wt % solution in water at 20° C.), 340.03 grams of demineralized water, 0.22 grams of V-501 (4,4′-Azobis(4-cyanovaleric acid)), and 0.21 grams of NaOH (21% solution) was then added to the reactor, after stopping agitation. Milling ensues after the addition of the water phase until the particle size was reached. The emulsion was then heated first to 75° C. and maintained at that temperature for 240 minutes and then heated to 95° C. for 360 min before cooling it down to 25° C. At that point, the slurry was evacuated from the reactor into a container to finish it. There were two types of finishing:
1. Perfume capsules-1 slurry: rheology modifier (Xanthan gum 1.59 grams) was added to the slurry. The rheology modifier was allowed to mix in for 30 min.
2. Perfume capsules-2 slurry: the pH of the slurry was adjusted with acetic acid to pH 4.0, and the slurry was allowed to mix for another 5 minutes. The cationic polysaccharide chitosan (Primex ChitoClear) was added over 5 minutes to a level of 0.4% by weight of the slurry. The slurry was mixed for another 10 minutes. The rheology modifier (microfibrillated cellulose) was added over 10 minutes to a level of 0.21% by weight of the slurry. The slurry was mixed for another 15 minutes. The pH of the slurry was adjusted to 5.1 through the addition of a 21.5% NaOH aqueous solution.

The result was a slurry of encapsulated perfume oil in core-shell polyacrylate capsules. The level of perfume oil in the perfume capsules was 54% by weight of the capsules. The level of isopropyl myristate in the perfume capsules was 44% by weight of the capsules.

Wash tests as described herein above were performed. The compositions shown in Table 1, were used, all the examples contain the same amount of perfume capsules, and if present, the same amount of cationic polysaccharide. The level of water and minors was adjusted, to keep the volume constant, when the polysaccharide-based cationic polymer was added to composition A1.

The level of non-ionic material (Tergitol 15-s-9 and Ethoxylated glycerol EO15) was adjusted, to keep the volume constant, when the polysaccharide-based cationic polymer was added to composition B3. Examples with asterisks are comparatives examples.

Example 1* mimics a traditional two-compartments unit-dose article wherein composition A1 represents a traditional detergent composition comprising perfume capsules, free from cationic polysaccharide. The head space concentration of the composition of Example 1* is used as reference 1. Composition A1 of comparative Examples 2*-5* comprise a cationic polysaccharide, at a level of 0.017% by weight of the composition of A1. Comparative Examples 2*-4* show that the addition of a cationic polysaccharide led to an increase in head space concentration of +27%, +24%, +11%, respectively. In the case of comparative Example 5*, the addition of the cationic polysaccharide led to a decrease in head space of −8%.

Example 6* mimics a three-compartment unit-dose article wherein B represents a traditional detergent composition and comprises the same total amount of perfume capsules as in Example 1* but they are delivered to the wash composition via composition B3. Example 6* had an increased head space concentration of +59% (index 159) as compared to Example 1*. The head space concentration of Example 6* is used as reference 2 for inventive Examples 7-10.

Inventive Examples 7-10 also deliver the same level of perfume capsules to the wash solution via composition B3, but composition B3 also comprises a cationic polysaccharide at a level of 0.2% by weight of the composition B3. As it can be seen from Table 2, the addition of cationic polysaccharide to composition B3 led to a further improvement in perfume head space, compared to Example 6*, of +35%, +28%, +41%, +10% for Examples 7-10, respectively.

It can be concluded that a higher perfume head space is observed when adding a cationic polysaccharide to a composition according to the disclosure (inventive examples 7-10) when compared to adding the same polysaccharide to a composition outside the scope of the disclosure (comparative examples 2*-5*).

The total amount of perfume capsules and cationic polysaccharide (if present) in the wash solution with inventive Examples 7-10 is the same as with comparative Examples 1*-6*, e.g. the difference in active level (wt %) within compositions A1 and B3 respectively is balanced by a different dosage volume of A1 and B3 to the wash solution.

Cationic polysaccharide 1: Supracare 150, available from Dow Chemical, cationic hydroxyethyl cellulose having a weight average molecular weight of 400 kDa, a charge density of 0.18, and an average weight percent of nitrogen per anhydroglucose repeat unit of 0.28%. Cationic polysaccharide 2: Quatin 350UP, available from Cosun Beet Company, cationically modified inulin (MW inulin backbone=3000 g/mol, cationic charge density=1.5 meq/g Cationic polysaccharide 3: Redibond 4000, available from Ingredion, cationically modified starch Cationic polysaccharide 4: ChitoClear, available from Primex, chitosan with about 80% degree of deacetylation.

TABLE 1
compositional details of Example 1-5

| Example | 1* | 2* | 3* | 4* | 5* |
|---|---|---|---|---|---|
| Composition | A | A | A | A | A |
| Cationic polysaccharide | None | 1 | 2 | 3 | 4 |
| Cationic polysaccharide | — | 0.017 | 0.017 | 0.017 | 0.017 |
| [% by weight of | | | | | |
| composition A1] | | | | | |
| HS vs ref 1 | 100 | 127 | 124 | 111 | 92 |
| | (ref 1) | | | | |

TABLE 2
compositional details of Example 6-10

| Example | 6* | 7 | 8 | 9 | 10 |
|---|---|---|---|---|---|
| Composition | B | B | B | B | B |
| Cationic polysaccharide | None | 1 | 2 | 3 | 4 |
| Cationic polysaccharide | — | 0.2 | 0.2 | 0.2 | 0.2 |
| [% by weight of | | | | | |
| composition B3] | | | | | |
| HS vs ref 2 | 100 | 135 | 128 | 141 | 110 |
| | (ref 2) | | | | |

### Composition A

Composition A is made by separately adding to the wash 19 ml of composition A1 and 1.6 ml of composition A2.

TABLE 3

| Composition | A1 | A2 |
|---|---|---|
| % by weight | | |
| Ethoxylated fatty alcohol (C12-14 E07-9) | 3.4 | 2.8 |
| Tergitol ™ 15-s-9¹ | — | — |
| Dodecyl Benzene Sulphonic Acid | 26.7 | 24.2 |
| Linear C12-C14 alkyl ether sulfate EO3 | 10.1 | 9.3 |
| Hydrogenated castor oil structurant | 0.1 | — |
| Ethoxylated glycerol EO15² | — | — |
| Propylene glycol | 17.1 | 22.1 |
| Glycerol | 4.7 | 9.7 |
| Potassium sulfite | 0.2 | 0.04 |
| MgCl2 | 0.3 | 0.3 |
| Polymer^{3a} | 1.5 | 1.44 |
| Polymer^{3b} | 1.9 | 1.75 |
| Polymer^{3c} | 2.6 | — |
| Enzyme⁴ | 0.2 | 0.1 |
| Brightener 49 | 0.3 | 0.01 |
| Dye | 0.01 | 0.7 |
| Na-HEDP chelant | 2.1 | 2.0 |
| DTPK Fatty Acid | 4.5 | 4.2 |
| Citric acid | 0.7 | 0.6 |
| Monoethanolamine | 10.0 | 9.1 |
| Perfume capsules-1⁵ | 0.7 | — |
| Minors | 2.6 | 3.7 |
| Water | Balance | Balance |

¹2-ethyl-hexyl alkoxylate with average degree of propoxylation of 5 and ethoxylation of 6, available from Dow
²Ethoxylated glycerol with an average degree of ethoxylation of 15, available from Sasol under the tradename Glicerodac-15
^{3a}Lutensol FP620 (ethoxylated polyethyleneimine polymer ex BASF),
^{3b}Lutensit Z96 (zwitterionic hexamethylene diamine ex BASF)
^{3c}amphiphilic graft polymer (polyethylene glycol graft polymer comprising a polyethylene glycol backbone (Pluriol E6000) and hydrophobic vinyl acetate side chains, comprising 40% by weight of the polymer system of a polyethylene glycol backbone polymer and 60% by weight of the polymer system of the grafted vinyl acetate side chain)
⁴mix of protease, amylase, phosphodiesterase, mannanase

### Composition B

Composition B is made by separately adding to the wash 19 ml of composition B1, 1.6 ml of composition B2 and 1.6 ml of composition B3.

TABLE 4

| Composition | B1 | B2 | B3 |
|---|---|---|---|
| % by weight | | | |
| Ethoxylated fatty alcohol (C12-14 E07-9) | 3.5 | 2.8 | — |
| Tergitol ™ 15-s-9¹ | — | — | 40 |
| Dodecyl Benzene Sulphonic Acid | 26.2 | 24.2 | — |
| Alkyl ether sulfate EO3 | 10.2 | 9.3 | — |
| Hydrogenated castor oil structurant | 0.1 | — | — |
| Ethoxylated glycerol EO15² | — | — | 40 |
| Propylene glycol | 17.4 | 22.1 | — |
| Glycerol | 4.8 | 9.7 | — |
| Potassium sulfite | 0.2 | 0.04 | — |
| MgCl2 | 0.3 | 0.3 | — |
| Polymer^{3a} | 1.5 | 1.44 | — |
| Polymer^{3b} | 1.9 | 1.75 | — |
| Polymer^{3c} | 2.6 | — | — |
| Enzyme⁴ | 0.2 | 0.1 | — |
| Brightener 49 | 0.3 | 0.01 | — |
| Dye | 0.008 | 0.7 | — |
| Na-HEDP chelant | 2.2 | 2.0 | — |
| DTPK Fatty Acid | 4.6 | 4.2 | — |
| Citric acid | 0.7 | 0.6 | — |
| Monoethanolamine | 10.1 | 9.1 | — |
| Perfume capsules -1 | — | — | 8.8 |
| Minors | 2.6 | 3.7 | 7.6 |
| Water | balance | balance | balance |

Unit-dose articles were prepared with separate compartments comprising liquid compositions, according to Table 5, enclosed by a polyvinyl alcohol film. The volume of compartment C1, C2, C3, and C4 was 19 ml, 1.6 ml, 1.5 ml, and 1.6 ml respectively. In examples 11* and 13* compartment C4 was left empty. The unit-dose articles were aged in a closed container for 1 week at 35° C. and then they were tested in wash tests and the head space above treated fabrics was measured as described herein above.

The total amount of perfume capsules delivered in the wash solution was the same for the Examples 11*-14.

Comparing comparative Example 12* with comparative Example 11*, it can be observed that the head space concentration increased 3.33 times when the perfume capsules were delivered in absence of a cationic polysaccharide through the composition enclosed in compartment C4 rather than through the composition enclosed in compartment C1.

Comparing inventive Example 14 with comparative Example 13*, it can be observed that the head space concentration increased more than 10 times when the perfume capsules were delivered in presence of a cationic polysaccharide through the composition enclosed in compartment C4 rather than through the composition enclosed in compartment C1.

It can be concluded that further presence of cationic polysaccharide increased the perfume head space impact when formulating the perfume capsule in a composition according to the disclosure.

The best perfume head space was observed when the cationic polysaccharide was added to the capsule slurry prior to the rheology modifier (perfume capsules−2).

TABLE 5

| % by weight of the liquid composition | | | | | | | | |
|---|---|---|---|---|---|---|---|---|
| per compartment | Example 11* | | | | Example 12* | | | |
| Compartment composition | C1 | C2 | C3 | C4 | C1 | C2 | C3 | C4 |
| water | Bal. | Bal. | Bal. | Bal. | Bal. | Bal. | Bal. | Bal. |
| Ethoxylated fatty alcohol (C12-14 EO7-9) | 3.5 | 2.8 | 2.2 | — | 3.5 | 2.8 | 2.2 | — |
| Dodecyl Benzene Sulphonic Acid | 27.2 | 24.2 | 28.7 | — | 27.2 | 24.2 | 28.7 | — |
| Alkyl ether sulfate EO3 | 10.2 | 9.2 | 10.9 | — | 10.2 | 9.2 | 10.9 | — |
| Hydrogenated castor oil structurant | 0.1 | — | 0.08 | — | 0.1 | — | 0.08 | — |
| Ethoxylated glycerol EO15² | — | — | — | — | — | — | — | 80.0 |
| Propylene glycol | 15.9 | 22.2 | 20.7 | — | 17.4 | 22.2 | 20.7 | — |
| Glycerol | 4.8 | 9.7 | 4.8 | — | 4.8 | 9.7 | 4.8 | — |
| Potassium sulfite | 0.2 | 0.04 | 0.4 | — | 0.195 | 0.04 | 0.4 | — |
| MgCl2 | 0.3 | 0.3 | 0.3 | — | 0.3 | 0.3 | 0.3 | — |
| Polymer^{3a} | 1.6 | 1.4 | 1.7 | — | 1.6 | 1.4 | 1.7 | — |
| Polymer^{3b} | 1.9 | 1.8 | 2.1 | — | 1.9 | 1.8 | 2.1 | — |
| Polymer^{3c} | 2.7 | — | — | — | 2.7 | — | — | — |
| Perfume capsules-1 | 0.7 | — | — | — | — | — | — | 8.8 |
| Perfume capsules-2 | — | — | — | — | — | — | — | — |
| Cationic polysaccharide-4 | — | — | — | — | — | — | — | — |
| Minors | 2.3 | 3.7 | 0.9 | — | 2.0 | 3.7 | 0.9 | 4.3 |
| Enzyme⁴ | 0.2 | 0.13 | — | — | 0.2 | 0.13 | — | — |
| Brightener 49 | 0.3 | 0.013 | 0.015 | — | 0.3 | 0.013 | 0.015 | — |
| Dye | 0.008 | 0.7 | 0.06 | — | 0.008 | 0.7 | 0.06 | — |
| NaHEDP chelant | 2.2 | 2.0 | 2.3 | — | 2.2 | 2.0 | 2.3 | — |
| DTPK Fatty Acid | 4.6 | 4.2 | 4.9 | — | 4.6 | 4.2 | 4.9 | — |
| Citric acid | 0.7 | 0.6 | 0.7 | — | 0.7 | 0.6 | 0.7 | — |
| Monoethanolamine | 10.1 | 9.1 | 10.7 | — | 10.1 | 9.1 | 10.7 | — |
| Relative HS | 100 (ref) | | | | 333 | | | |
| % by weight of the liquid composition | | | | | | | | |
| per compartment | Example 13* | | | | Example 14 | | | |
| Compartment | C1 | C2 | C3 | C4 | C1 | C2 | C3 | C4 |
| water | Bal. | Bal. | Bal. | Bal. | Bal. | Bal. | Bal. | Bal. |
| Ethoxylated fatty alcohol (C12-14 EO7-9) | 3.5 | 2.8 | 2.2 | — | 3.5 | 2.8 | 2.2 | — |
| Dodecyl Benzene Sulphonic Acid | 27.2 | 24.2 | 28.7 | — | 27.2 | 24.2 | 28.7 | — |
| Alkyl ether sulfate EO3 | 10.2 | 9.2 | 10.9 | — | 10.2 | 9.2 | 10.9 | — |
| Hydrogenated castor oil structurant | 0.1 | — | 0.08 | — | 0.1 | — | 0.08 | — |
| Ethoxylated glycerol EO15² | — | — | — | — | — | — | — | 77.8 |
| Propylene glycol | 15.7 | 22.1 | 20.7 | — | 17.4 | 22.2 | 20.7 | — |
| Glycerol | 4.8 | 9.7 | 4.8 | — | 4.8 | 9.7 | 4.8 | — |
| Potassium sulfite | 0.2 | 0.04 | 0.4 | — | 0.195 | 0.04 | 0.4 | — |
| MgCl2 | 0.3 | 0.3 | 0.3 | — | 0.3 | 0.3 | 0.3 | — |
| Polymer^{3a} | 1.6 | 1.4 | 1.7 | — | 1.6 | 1.4 | 1.7 | — |
| Polymer^{3b} | 1.9 | 1.8 | 2.1 | — | 1.9 | 1.8 | 2.1 | — |
| Polymer^{3c} | 2.7 | — | — | — | 2.7 | — | — | — |
| Perfume capsules-1 | — | — | — | — | — | — | — | — |
| Perfume capsules-2 | 0.7 | — | — | — | — | — | — | 8.8 |
| Cationic polysaccharide-4 | 0.0013 | — | — | — | — | — | — | 0.08 |
| Minors | 2.4 | 3.7 | 0.9 | — | 2.0 | 3.7 | 0.9 | 5.2 |
| Enzyme | 0.2 | 0.1 | — | — | 0.2 | 0.13 | — | — |
| Brightener 49 | 0.3 | 0.013 | 0.015 | — | 0.3 | 0.013 | 0.015 | — |
| Dye | 0.008 | 0.7 | 0.06 | — | 0.008 | 0.7 | 0.06 | — |
| NaHEDP | 2.2 | 2.0 | 2.3 | — | 2.2 | 2.0 | 2.3 | — |
| Fatty Acid | 4.6 | 4.2 | 4.9 | — | 4.6 | 4.2 | 4.9 | — |
| Citric acid | 0.7 | 0.6 | 0.7 | — | 0.7 | 0.6 | 0.7 | — |
| Monoethanolamine | 10.1 | 9.1 | 10.7 | — | 10.1 | 9.1 | 10.7 | — |

| | | |
|---|---|---|
| Relative HS | 82 | 1013 |

As used in this specification and the claims that follow, the articles “a”, “an”, and “the” include singular and plural references unless the context clearly dictates otherwise. As such, the terms “a” or “an”, “one or more” and “at least one” can be used interchangeably herein. Thus, for example, “a component” may include one or more components unless the reference is specifically indicated as being singular.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to anything disclosed or claimed herein or that it alone, or in any combination with any other reference or references, teaches, suggests or discloses anything disclosed or claimed herein. Further, to the extent that any meaning or definition of a term in this document conflicts with any meaning or definition of the same term in a document incorporated by reference, the meaning or definition assigned to that term in this document shall govern.

While particular forms of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of the present disclosure.

What is claimed is:

1. A liquid composition comprising:
i) from about 5% to about 90% by weight of the composition of a nonionic material selected from the group consisting of non-ionic surfactants, non-aqueous organic solvents, and a mixture thereof;
ii) from about 1% to about 50% by weight of the composition of perfume capsules, wherein the capsules have a core and a shell and wherein the shell surrounds the core;
wherein the core comprises a perfume;
iii) from about 0.01% to about 5% by weight of the composition of a polysaccharide-based cationic polymer;
iv) up to about 25% by weight of the composition of water; and
v) less than about 5% by weight of the composition of anionic surfactant.

2. A liquid composition according to claim 1, wherein the non-ionic surfactant is selected from the group consisting of:
i) an alcohol alkoxylated nonionic surfactant comprising an alkoxylated secondary alcohol nonionic surfactant comprising an ethoxylated secondary alcohol nonionic surfactant having a total average alkyl chain length of from about 5 to about 20 carbon atoms;
ii) a branched alkoxylated primary alcohol nonionic surfactant comprising a branched alkoxylated C6-C16 primary alcohol nonionic surfactant derived from an alcohol selected from the group consisting of methyl hexanol, ethyl hexanol, propyl hexanol, dimethyl hexanol, trimethyl hexanol, methyl heptanol, ethyl heptanol, propyl heptanol, dimethyl heptanol, trimethyl heptanol, methyl octanol, ethyl octanol, propyl octanol, butyl octanol, dimethyl octanol, trimethyl octanol, methyl nonanol, ethyl nonanol, propyl nonanol, butyl nonanol, dimethyl nonanol, trimethyl nonanol, methyl decanol, ethyl decanol, propyl decanol, butyl decanol, dimethyl decanol, trimethyl decanol, methyl undecanol, ethyl undecanol, propyl undecanol, butyl undecanol, dimethyl undecanol, trimethyl undecanol, methyl dodecanol, ethyl dodecanol, propyl dodecanol, butyl dodecanol, dimethyl dodecanol, trimethyl dodecanol, and mixtures thereof, and wherein the branched alkoxylated C6-C16 primary alcohol has on average from about 1 to about 30 ethoxylate units;
iii) a branched alkoxylated primary alcohol nonionic surfactant comprising an alkoxylated guerbet alcohol nonionic surfactant selected from the group consisting of alkoxylated C8 guerbet alcohol nonionic surfactant, alkoxylated C10 guerbet alcohol nonionic surfactant; alkoxylated C12 guerbet alcohol, and a mixture thereof, with on average from about 1 to about 14 alkoxylate units;
iv) a linear alcohol alkoxylated nonionic surfactant comprising a C8 to C18, linear alkyl chain, and comprises from about 1 to about 30 ethoxylate units; and
v) an ethylene oxide-propylene oxide triblock copolymer having one of the following structures:
a) an ethylene oxide-propylene oxide-ethylene oxide (EO/PO/EO) triblock copolymer, wherein the copolymer comprises a first EO block, a second EO block and PO block and wherein the first EO block and the second EO block are linked to the PO block; or
b) a propylene oxide-ethylene oxide-propylene oxide (PO/EO/PO) triblock copolymer, wherein the copolymer comprises a first PO block, a second PO block and EO block and wherein the first PO block and the second PO block are linked to the EO block.

3. A liquid composition according to claim 1, wherein the composition comprises a non-aqueous organic solvent selected from the group consisting of:
i) glycerol, polyethylene glycol, and a mixture thereof;
ii) polyglycerol, alkoxylated polyol, alkoxylated polyol ester, and a mixture thereof, wherein the polyol has from about 3 to about 5 hydroxyl groups; and/or
iii) polypropylene glycol having a number average molecular weight of from about 700 Da to about 5000 Da.

4. A liquid composition according to claim 1, wherein the polysaccharide-based cationic polymer comprises a backbone selected from cellulose, starch, glycogen, guar, dextran, polyglucan, chitin, pectin, curdlan, xylose, inulin, pullulan, locust bean gum, cassia gum, tamarind gum (xyloglucan), xanthan gum, amylose, amylopectin, scleroglucan, and any combination thereof.

5. A liquid composition according to claim 1, wherein the polysaccharide-based cationic polymer is selected from cationic modified cellulose, cationic modified dextran, cationic modified polyglucan, cationic modified guar, cationic modified inulin, cationic modified starch, chitosan and any combination thereof.

6. A liquid composition according to claim 1, wherein the perfume capsules are coated with the polysaccharide-based cationic polymer.

7. A liquid composition according to claim 1, wherein the composition comprises less than about 3%, preferably less than about 1% by weight of the composition of anionic surfactant.

8. A liquid composition according to claim 1 wherein the composition has a pH of from about 4 to about 8 as measured in a 10% weight solution in demineralized water at 20° C.

9. A unit-dose article comprising a water-soluble film creating a first compartment and a second compartment, wherein the first compartment comprises a first liquid composition comprising:
i) from about 5% to about 90% by weight of the composition of a nonionic material selected from the group consisting of non-ionic surfactants, non-aqueous organic solvents, and a mixture thereof;
ii) from about 1% to about 50% by weight of the composition of perfume capsules, wherein the capsules have a core and a shell and wherein the shell surrounds the core;
wherein the core comprises a perfume;
iii) from about 0.01% to about 5% by weight of the composition of a polysaccharide-based cationic polymer;
iv) up to about 25% by weight of the composition of water; and
v) less than about 5% by weight of the composition of anionic surfactant; and
wherein the second compartment comprises a second composition comprising a surfactant and a cleaning adjunct.

10. The unit-dose article according to claim 9, wherein the surfactant of the second composition comprises an anionic surfactant and a non-ionic surfactant.

11. The unit-dose article according to claim 9, wherein the cleaning adjunct of the second composition is selected from the group consisting of: enzymes, anti-redeposition agents, neutralizers, optical brighteners, foam inhibitors, chelators, bittering agents, dye transfer inhibitors, soil release agents, water softeners, electrolytes, pH regulators, anti-graying agents, anti-crease components, colorants, scents, processing aids, and mixtures thereof.

12. The unit-dose article according to claim 9, wherein the cleaning adjunct of the second composition comprises an enzyme selected from the group consisting of proteases, amylases, cellulases, lipases, xyloglucanases, mannanases, nucleases, pectate lyases, and a mixture thereof.

13. The unit-dose article according to claim 9, wherein the second composition is a liquid composition.

14. The unit-dose article according to claim 9, wherein the second composition comprises an organic solvent selected from the group consisting of: 1,2-propanediol, dipropylene glycol, tripropyleneglycol, glycerol, sorbitol, polyethylene glycol, and a mixture thereof.

15. The unit-dose article according to claim 9, wherein the first and/or second composition comprises a free perfume.

16. A method of making a composition according to claim 1, the method comprising the steps of:
i) mixing the perfume capsules with the polysaccharide-based cationic polymer; and optionally
ii) adding an additional polymer, preferably a rheology modifier, to the mixture resulting from step i).
